(19) United States
(12) Patent Application Publication
(10) Pub. No.: US 2003/0136356 A1
(43) Pub. Date: Jul. 24, 2003

(54) Piston compressed turbine engine and control method thereof

(76) Inventor: Young Namkung, Seoul (KR)

Correspondence Address: CANTOR COLBURN, LLP, 55 GRIFFIN ROAD SOUTH, BLOOMFIELD, CT, 06002

(21) Appl. No.: 10/307,010

(22) Filed: Nov. 27, 2002

(30) Foreign Application Priority Data
Dec. 22, 2001 (KR) 2001-83350

(51) Int. Cl. F02B 3/00

(52) U.S. Cl. 123/27 R; 123/51 R; 123/51 BC

(57) ABSTRACT

In a piston compressed turbine engine, the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston. The piston compressed turbine engine is controlled by drawing air or air-fuel mixture into the cylinder as the intake valve is open and the piston retreats (a retreat act), pausing the piston at the BDC for a predetermined time so that the delay in intake due to inertia of the inducted air or air-fuel mixture is removed (a pause-at-BDC act), compressing the air or air-fuel mixture as the piston advances (an advancing act), and pausing the piston at the TDC for a predetermined time so that constant volume combustion is performed during explosion and combustion gas rotates the turbine after combustion is completed and then is exhausted (an pause-at-TDC act). Thus, a superior thermodynamic performance analyzed using the air cycle can be obtained along with high output and efficiency. Since the power shaft of the turbine and the shaft of the piston are arranged parallel to each other, a compact engine is possible. Since the emission of contaminants is prevented, the engine is pro-environmental. The control and manufacture of an engine are made easy.

### BACKGROUND OF THE INVENTION

1. Field of the Invention

The present invention relates to a piston compressed turbine engine and a control method thereof, and more particularly, to a piston compressed turbine engine which can maximize efficiency by incorporating the advantages of a piston engine and the advantages of a turbine engine, and to a control method thereof.

2. Description of the Related Art

In general, an internal combustion engine, which performs combustion of fuel directly in an engine, generates power by means of continuous processes of intake, compression, combustion, expansion and exhaust. The internal combustion engine can be classified into reciprocating type and rotating type. That is, a reciprocating type internal combustion engine, so-called a piston engine, directly burns the fuel in a combustion chamber that is formed of a cylinder, a cylinder head and a piston. Explosive energy generated during the combustion process is transmitted to the piston to rotate the crank shaft by means of a connecting rod and a crank mechanism and is converted into rotational power. The reciprocating type internal combustion engine is a discontinuous power generating apparatus in which intake, compression, combustion, expansion and exhaust are repeated at the same compartment.

On the other hand, a rotating type internal combustion engine is a gas turbine engine in which air is drew into and compressed by a compressor, fuel is burned in a separate combustion chamber, and rotational power is generated from the rotation of turbine blade by the explosive energy generated during the combustion. The rotating type internal combustion engine is a continuous power generating apparatus in which compression, combustion and expansion are made at different compartments.

Despite of its disadvantages such as severe vibration and heavy weight per the output power, the reciprocating type engine (hereinafter, referred to as the piston engine) is widely used for small land transportations such as automobiles, etc. due to its lower price and high efficiency.

The rotating type engine (hereinafter, referred to as the turbine engine) is an ideal engine having the advantages such as low vibration and great power output per the weight of the engine. However, the turbine engine have higher r.p.m. and most parts are continuously exposed to heat. Therefore manufacturing and cooling of the engine is difficult and the use of a turbine engine is limited to aircrafts or high output power engine.

Thus, the piston engine and the turbine engine have been developed separately due to their advantages and disadvantages. However, to take the advantages of the piston engine and the turbine engine and minimize disadvantages thereof, a new type engine having a new power generating mechanism different from the existing piston engine and the turbine engine is needed.

### SUMMARY OF THE INVENTION

As a solution of the above-described problems, it is the object of the present invention to provide a highly efficient piston compressed turbine engine and its control method. The present invention can generate a higher output power at a greater efficiency compared to other conventional engines in thermodynamic performance analyzed using ideal air standard cycle, minimize the heat loss due to the combustion delay which is inevitable in case of the high speed operation at the piston engine, reduce the cooling load by limiting the contact area with combustion gas of high temperature, avoid the loss of exhaust gas by adjusting the gas exhaust duration, and decrease the mechanical friction loss since the piston pauses during the combustion and exhaust processes in which high pressure is generated due to a combustion gas. And a greater power can be obtained at a low R.P.M.

It is another object of the present invention to provide a pro-environmental, high-performance piston compressed turbine engine, and a control method thereof. The present invention has a high effective compression ratio and a high volumetric efficiency since inertia effect can be reduced during the intake process and operation at a low rotational speed is possible, can burn fuel-air mixture completely by a constant-volume combustion since a flame propagation distance is short during the combustion process, can reduce noise and vibration since rotation power is generated directly from the turbine and the pressure of exhaust gas at the turbine outlet is low, does not have a pump loss since there is no exhaust stroke of a piston, and can limit exhaust of pollutants because complete combustion can be carried out by a constant-volume combustion.

It is yet anther object of the present invention to provide a futuristic piston compressed turbine engine, and a control method thereof, in which a power shaft of the turbine and shaft of a pistons are arranged parallel to each other and all control equipments are operated by being directly engaged with the power shaft of the turbine. Such structure can simplify the mechanical apparatuses and components, realize a compact and light engine, and facilitate the optimal control of engine components such as movement speed and pause time of a piston linearly reciprocating, etc. And each part can be optimally manufactured.

To achieve the above objects, there is provided a piston compressed turbine engine wherein the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston. To achieve the above objects, there is provided a piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and the piston is paused for a predetermined time at the TDC during the explosion so that constant volume combustion of air-fuel mixture is performed.

To achieve the above objects, there is provided a piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and an oscillating cam assembly having a track formed therein for oscillating a piston rod when the rotor rotates is installed between the power shaft of the turbine portion and the piston rod of the piston portion to control the reciprocation of the piston.

It is preferred in the present invention that the track comprises a retreat section in which air or air-fuel mixture is drew into the cylinder as piston retreats, a pause-at-BDC section in which the piston pauses for a predetermined time at the BDC so that delay in intake due to inertia of the inducted air or air-fuel mixture can be reduced, an advancing section in which the inducted air or air-fuel mixture is compressed as the piston advances, and a pause-at-TDC section in which the piston pauses for a predetermined time at the TDC so that the compressed air-fuel mixture explodes in the constant volume state and combustion gas generates power and exhausted after the combustion is completed.

To achieve the above objects, there is provided a piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and ideal gas standard cycle of the air or air-fuel mixture in the engine is controlled to form an constant-pressure curve during the intake, an adiabatic compression curve during the compression, a constant-volume curve during the combustion, an adiabatic expansion curve during the generation of power, and an constant-pressure curve during the exhaust.

To achieve the above objects, there is provided a piston compressed turbine engine comprising a piston portion where air or air-fuel mixture is drew into a cylinder and compressed by a piston that repeats reciprocation and pause, the compressed air-fuel mixture explodes, and a high pressure combustion gas generated during the explosion is exhausted, a turbine portion where an rotational power of a power shaft is generated using the high-pressure combustion gas exhausted from the piston, and a controlling apparatus which transfers part of the rotational power generated at the turbine portion to the piston portion and controls reciprocation of the piston so that the piston of the piston portion retreats during the intake of the air or air-fuel mixture, advances during compression, and pauses during combustion and expansion/exhaust of the combustion gas.

It is preferred in the present invention that the piston portion comprises a cylinder block in which an intake manifold and an exhaust manifold are installed at the front side of the cylinder block, a combustion chamber is separately formed to reduce a contact area between the piston and the combustion gas, and a piston is inserted into the rear side of the cylinder block, a piston head installed to be capable of sliding by being inserted into a cylinder of the cylinder block, a piston rod connected to the rear side of the piston head and extending outside the cylinder block, an intake valve installed at the intake manifold of the cylinder block for opening and closing an intake manifold to control flow of the air or air-fuel mixture drew into the cylinder, an intake valve cam assembly connected to the power shaft of the turbine portion for converting a rotational movement of the power shaft to reciprocation of the intake valve, an exhaust valve installed at the exhaust manifold of the cylinder block for opening and closing an exhaust manifold to control flow of the combustion gas exhaust outside the cylinder, and an exhaust valve cam assembly connected to the power shaft of the turbine portion for converting a rotational movement of the power shaft to reciprocation of the exhaust valve.

It is preferred in the present invention that the turbine portion comprises a power shaft installed at the center of the cylinder block to be able to rotate freely, and a impeller connected to the power shaft, installed at an integrated exhaust manifold formed by incorporating numbers of exhaust manifolds of the cylinder block, and rotating by the energy of the combustion gas exhausted from the exhaust manifolds.

It is preferred in the present invention that the controlling apparatus is an oscillating cam assembly for oscillating the piston rod by a rotor where ascending/descending track with protrusion and depression is engraved, and that the oscillation cam assembly comprises a piston cam rotor, rotating together with the power shaft, in which a piston ascending/descending track with protrusion and depression in which the bearing ball is inserted and slides so that the piston rod reciprocates together with the bearing ball is engraved and a fixing shaft is at the center thereof to fix to or detach from the power shaft, and a bearing ball installed at one end of the piston rod and inserted into the piston cam rotor to convert rotation of the power shaft to reciprocation of the piston rod.

It is preferred in the present invention that the piston ascending/descending track comprises a retreat section in which air or air fuel mixture is drew into the cylinder as the piston retreats, a pause-at-BDC section in which the piston pauses at the BDC for a predetermined time to reduce a delay in intake due to inertia of the inducted air or air-fuel mixture, an advancing section in which the inducted air or air-fuel mixture is compressed as the piston advances, and a pause-at-TDC section in which the piston pauses at the TDC for a predetermined time, constant volume combustion is proceeded, and after combustion is completed, a combustion gas rotates the turbine and is exhausted, wherein the height and inclination of the track (the height and position of mountain and furrow) are determined corresponding to an intake stroke, a compression stroke, a combustion process, and an expansion/exhaust process in harmony with the operation of the intake valve and exhaust valve.

To achieve the above objects, there is provided a method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston, the method comprising the acts of drawing air or air-fuel mixture into the cylinder as the intake valve is open and the piston retreats (a retreat act), pausing the piston at the BDC for a predetermined time so that the delay in intake due to inertia of the inducted air or air-fuel mixture is removed (a pause-at-BDC act), compressing the air or air-fuel mixture as the piston advances (an advancing act), and pausing the piston at the TDC for a predetermined time so that constant volume combustion is performed during explosion and combustion gas rotates the turbine after combustion is completed and then is exhausted (an pause-at-TDC act).

To achieve the above objects, there is provided a method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston, wherein air cycle of the air or air-fuel mixture in the engine is controlled to form an constant-pressure curve during intake, an adiabatic compression curve during compression, a constant volume curve during combustion, an adiabatic expansion curve during expansion, that is, the generation of power, and an constant pressure curve during exhaust.

To achieve the above objects, there is provided a method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and an oscillating cam assembly having a track formed therein for oscillating a piston rod by a rotor that rotates is installed between the power shaft of the turbine and the piston to control the reciprocation of the piston, wherein, to change a rotational torque output of the engine during one turn of the power shaft, a rotational torque is controlled by forming a cycle including the retreat section, the pause-at-BDC section, the advancing section, and the pause-at-TDC section to repeat N times in the track so that N times of combustion per cylinder are made while the power shaft of the turbine portion rotate one turn.

### BRIEF DESCRIPTION OF THE DRAWINGS

The above object and advantages of the present invention will become more apparent by describing preferred embodiments thereof in detail with reference to the attached drawings in which:

FIG. 1 is a vertical sectional view showing a piston compressed turbine engine according to a preferred embodiment of the present invention;

FIG. 2 is an unfolding view showing a track which guides movement of the piston of FIG. 1;

FIGS. 3 through 6 are unfolding views showing the piston guide tracks in various embodiments in which the piston cycle is repeated in multiple numbers per rotation of power shaft;

FIGS. 7A through 7H are horizontal sectional views showing various types of the cylinder arrangement of FIG. 1;

FIG. 8 is a vertical sectional view showing a piston compressed turbine engine according to another preferred embodiment of the present invention;

FIGS. 9A through 9D are views showing the state of a piston rod which can move through the butterfly-type window of a cylinder base and the state of a piston rod which is locked firmly at a cylinder block, step by step;

FIG. 10 is a view showing the cylinder base and the piston rod of FIG. 8 and sections of the piston rod taken along lines A-A, B-B, C-C, D-D, E-E, F-F and G-G;

FIGS. 11A through 11D are views showing the state in which the piston head of FIG. 8 axially rotates, step by step;

FIGS. 12A through 12B are magnified side views showing the state of toothed surface of piston rod of FIG. 11 which contact with the toothed surface of the piston head before and after axial rotating, respectively;

FIGS. 13 through 22 are vertical sectional views showing the operational state of a cylinder of the piston compressed turbine engine of FIG. 8, step by step:

FIG. 23 is pressure-volume diagrams of ideal gas standard cycles of the piston compressed turbine engine of the present invention and the conventional engines;

FIG. 24 is a table showing characteristics of the piston compressed turbine engine of the present invention based on FIG. 23 and the conventional engines;

FIG. 25 is a partially cut-away perspective view showing an example of the piston compressed turbine engine of FIG. 1;

FIG. 26 is an exploded perspective view showing an example of the piston compressed turbine engine of FIG. 8;

FIG. 27 is a sectional view showing a piston compressed turbine engine connected in series according to yet another preferred embodiment of the present invention;

FIG. 28 is a sectional view showing a piston compressed turbine engine connected to face each other according to yet further another preferred embodiment of the present invention; and

FIG. 29 is an unfolding view showing piston guide tracks of a piston compressed turbine engine of FIG. 28 connected to face each other.

### DETAILED DESCRIPTION OF THE INVENTION

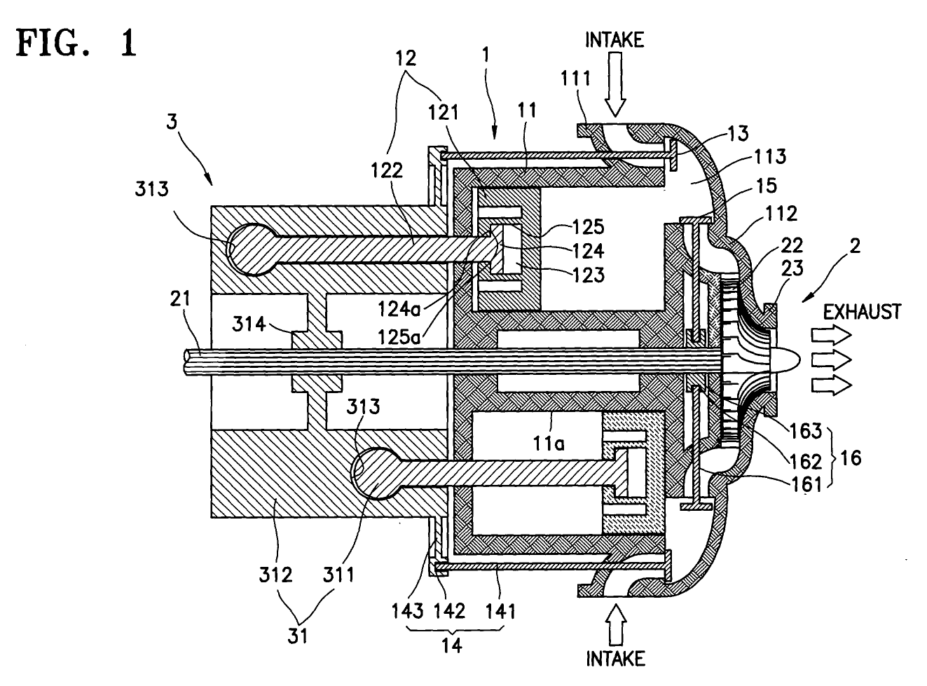

As shown in FIG. 1, a piston compressed turbine engine according to a preferred embodiment of the present invention includes a piston portion 1, a turbine portion 2 and a controlling apparatus 3. At the piston portion 1, air or air-fuel mixture is drew into a cylinder 11a and compressed by a piston 12 that repeats reciprocation and pause, the compressed air-fuel mixture explodes, and a high pressure combustion gas generated during the explosion is exhausted. Piston portion 1 includes a cylinder block 11, pistons 12, intake valves 13, an intake valve cam assembly 14, exhaust valves 15, and an exhaust valve cam assembly 16. Here, the piston 12 includes a piston head 121 and a piston rod 122.

The turbine portion 2 generates a rotational power of a power shaft 21 using the high-pressure combustion gas exhausted from the piston portion 1. The turbine portion 2 includes a power shaft 21 installed through the center of the piston portion 1 to be able to rotate freely and an impeller 22 connected at one end of the power shaft 21.

The controlling apparatus 3 transfers part of the rotational power generated at the turbine portion 2 to the piston portion 1 and controls reciprocation of the piston 12 of the piston portion 1. The piston 12 moves from TDC(Top Dead Center) to BDC(Bottom Dead Center) during intake of air or air-fuel mixture, moves from BDC to TDC during compression, and pauses at TDC during combustion of air-fuel mixture and expansion/exhaust of combustion gas. A variety of the controlling apparatuses for controlling the movement of the piston 12 may be installed between the piston portion 1 and the turbine portion 2. Preferably, an oscillating cam assembly 31, which changes a rotational movement of the power shaft 21 of the turbine portion 2 into a linear movement of the piston 12 of the piston portion 1, is installed as the controlling apparatus 3.

The more detailed structure of each of the piston portion 1, the turbine portion 2, and the controlling apparatus 3 according to a preferred embodiment of the present invention and the operational relationship therebetween will be described below.

As shown in FIG. 1, in the piston portion 1, the piston heads 121 and the piston rods 122 are inserted in the cylinder block 11, and the intake valves 13 and the intake valve cam assembly 14, and the exhaust valves 15 and the exhaust valve cam assembly 16, are installed. Also, in the cylinder block 11, cylinders 11a, where the piston 12 is inserted, are formed at the rear portion, an intake manifold 111 and an exhaust manifold 112 are installed at the front, and a compartment encompassed by the cylinder block 11, the upper surface of the piston head 121, the intake valve 13 and the exhaust valve 15 forms a combustion chamber 113. It is completely different from the cylinder of a conventional piston engine that the cylinders 11a are arranged circularly around the power shaft 21 at an identical angle and parallel to each other and the bottom of the cylinder 11a is closed except the rod-guiding window to guide the movement of piston-rod or lock the piston-rod firmly.

A combustion chamber in a conventional piston engine is designed considering an efficient intake of air or air-fuel mixture, an efficient combustion, transmission of pressure to a piston during expansion stroke, and exhaust of combustion gas. On the other hand, the combustion chamber 113 of the piston compressed turbine engine of the present invention is designed to minimize the area of the piston head 121 receiving high pressure of the combustion gas formed in the combustion chamber 113 during the combustion and expansion/exhaust process so that the total pressure acting on the piston head 121 is minimized. Thus, in the combustion chamber 113 of the piston compressed turbine engine of the present invention, only a part of the upper surface of the piston head 121 contacts the combustion chamber 113 to reduce contact area between the piston head 121 and combustion gas, as shown in FIG. 1.

Contrary to the conventional piston engine in which the pressure of the combustion gas directly transmitted to the piston head during expansion stroke is transformed into power and exhaust stroke is merely exhaustion of low pressure combustion gas out of the engine, in the present invention, the total pressure transmitted to the piston head 121 during explosion process is minimized and high pressure combustion gas is directly exhausted into the turbine portion 2 through the exhaust valve 15, and collides with the impeller 22 so that the turbine portion 2 generates rotational power of the power shaft 21. Thus, the power generation principle is fundamentally different from that of the conventional piston engine.

Also, unlike the case of the conventional piston engine in which cooling of the piston is complicated because the piston continues to move, in the piston compressed turbine engine of the present invention, the piston head 121 can be easily cooled by heat transmission from the piston head 121 to the cylinder block 11 which maintains relatively low temperature by means of a cooling apparatus, via contacting area between the upper surface of the piston head 121 and the inner surface of the cylinder block 11 facing the piston head 121. As shown in FIG. 1, when the air or air-fuel mixture is completely compressed, the contacting area between the upper surface of the piston head 121 and the inner surface of the cylinder block 11 facing the piston head 121 is maximized and close contact state between the upper surface of the piston head 121 and the inner surface of the cylinder block 11 facing the piston head 121 is maintained throughout the combustion and expansion/exhaust processes, and more detailed operation of above will be described later.

Also, the piston head 121 of the present invention is inserted and is enabled to slide in the cylinder 11a of the cylinder block 11. And the piston rod 122 is connected to the rear portion of the piston head 121 and extends outside the cylinder block 11.

Unlike a conventional piston engine having a mechanism which has crank angle when reciprocate to connect a crank shaft and a piston, the piston rod 122 of the present invention is connected to the piston head 121 perpendicularly and reciprocates linearly in a direction parallel with the power shaft 21.

Thus, in the piston portion 1 of the present invention, unlike the conventional piston engine, the piston rod 122 is simply connected to the piston head 121 without a conventional pivot mechanism or any other joint mechanism therebetween. Accordingly, mechanical impact or joint friction between the piston head 121 and the piston rod 122 is less. Also, it is another characteristic feature of the piston portion 1 of the present invention that the piston 12 is intermittently paused at TDC or BDC without movement for a predetermined time by the controlling apparatus 3, which will be described in detail later. This is different from the conventional piston engine in which piston head and piston rod continuously repeat reciprocation without a pause as long as the engine is operated.

Although no additional joint mechanism is required between the piston head 121 and the piston rod 122, to reduce an impact applied to the piston rod 122 by way of the piston head 121, a shock absorber 123 simply formed of a hydraulic cylinder or damping member can be installed between the piston head 121 and the piston rod 122. Thus, an impact applied to the piston head 121 during the explosion of fuel is prevented from being transmitted directly to the piston rod 122, thus reducing a mechanical impact.

In the meantime, the intake valve 13 is installed at the outlet of the intake manifold 111 of the cylinder block 11 and reciprocates to open/close the intake manifold 111 so that the flow of air or air-fuel mixture sucked into the cylinder 11a is controlled. The intake valve 13 is operated by the intake valve cam assembly 14 connected to the power shaft 21 of the turbine portion 2 and converting the rotational movement of the power shaft 21 into a reciprocation movement of the intake valve 13.

Also, the exhaust valve 15 is installed at the inlet of the exhaust manifold 112 of the cylinder block 11 and reciprocates to open/close the exhaust manifold 112 so that the flow of combustion gas exhausted out of the cylinder 11a is controlled. The exhaust valve 15 is operated by the exhaust valve cam assembly 16 connected to the power shaft 21 of the turbine portion 2 and converting the rotational movement of the power shaft 21 into a reciprocation movement of the exhaust valve 15.

A variety of cam assemblies capable of controlling the opening and closing time of the intake valve 13 and the exhaust valve 15 corresponding to a rotational angle of the power shaft 21 can be used as the intake valve cam assembly 14 and the exhaust valve cam assembly 16. Preferably, as shown in FIG. 1, the intake valve cam assembly 14 is located at the outer circumferential surface of the cylinder block 11 and includes a intake valve rod 141 connected to the intake valve 13, a intake valve cam track 142 having protrusion and depression formed in the intake valve cam rotor 143 in which an end portion of the intake valve rod 141 contacts the edge thereof and slide, and a intake valve cam rotor 143 connected to the power shaft 21 and rotating together with the power shaft 21.

Also, the exhaust valve cam assembly 16 is preferably located at the front side of the inside of the cylinder block 11 and includes a exhaust valve rod 161 connected to the exhaust valve 15, a exhaust valve cam track 162 having protrusion and depression formed in the exhaust valve cam rotor 163 in which an end portion of the exhaust valve rod 161 contacts the edge thereof and slide, and an exhaust valve cam rotor 163 connected to the power shaft 21 and rotating together with the power shaft 21.

That is, the opening/closing operation of the intake valve 13 and the exhaust valve 15 are controlled by the rotational angles of the intake valve cam rotor 143 and the exhaust valve cam rotor 163 and the shapes of the protrusion and depression of the intake valve cam track 142 and the exhaust valve cam track 162.

Here, the structures of the intake valve cam assembly 14 and the exhaust valve cam assembly 16 can be modified or changed by those skilled in the art. Also, the intake valve cam track 142 and the exhaust valve cam track 162 can be arranged and modified in various ways.

Also, a poppet valve that is generally used for an automobile engine can be used as the intake valve 13. Since it is critical that thermal energy of the combustion gas in the combustion chamber shall be transmitted to the turbine portion 2 with minimum loss during the power process, it is preferable to locate the combustion chamber 113 and the impeller 22 of the turbine portion 2 as close as possible. Thus, not only a poppet valve but also a sliding-sleeve valve or a rotary valve can be used as the exhaust valve 15.

Although not shown in the drawing, the combustion in the piston compressed turbine engine of the present invention is performed not only by a spark ignition method of forcibly igniting a compressed air-fuel mixture, but also by a spontaneous ignition method of injecting fuel to the high pressure compressed air to be spontaneously ignited. The spark ignition method needs a plug type igniter and a controller for controlling the igniter. These ignition methods of the piston compressed turbine engine are well known technologies and thus modification thereof by those skilled in the art can be easily made.

As shown in FIG. 1, the turbine portion 2 of the present invention installed adjacent to the piston portion 1 includes the power shaft 21 and the impeller 22. The power shaft 21 is installed at the center of the cylinder block 11 to be able to rotate freely. The impeller 22 is connected to one end of the power shaft 21 and installed in an integrated exhaust manifold 23 around which a plurality of exhaust manifolds 112 of the cylinder block 11 are connected circularly. The impeller 22 is rotated by a force of the combustion gas exhausted from the exhaust manifolds 112 at different angles.

Thus, as the high pressure combustion gas exhausted at different angles from the piston portion 1 toward the integrated exhaust manifold 23 collide with the impeller 22, the impeller 22 is rotated, and a rotational power of the power shaft 21 connected to the impeller 22 is generated.

That is, the piston compressed turbine engine of the present invention generates a rotational power by rotating the power shaft 21 of the turbine portion 2 by using the high-pressure combustion gas exhausted from the piston portion 1. Although the present invention is similar to the conventional turbine engine in that a difference in the hydraulic pressure between inlet and outlet of the impeller 22 is used, however, the present invention is quite different from the conventional turbine engine in that intake, compression, and combustion are all proceeded in the piston portion 1. Also, it is characteristic in the present invention that the intake, compression, and combustion processes occurring in the piston portion 1 are all controlled by a rotational angle of the power shaft 21.

Also, although not shown in the drawing, any cooling apparatuses having various shapes and types can be used as a cooling apparatus for cooling the impeller 22. Preferably, auxiliary compression cylinders for compressing the external air using rotational power of the power shaft 21 and exhausting the compressed air toward the impeller 22 can be installed.

To control the auxiliary compression cylinders, a protrusion and depression type cam assembly having the same structure as that of the controlling apparatus 3 for the piston portion 1 to be described later can be applied.

Thus, cold compressed air generated by the auxiliary compression cylinders cools the impeller 22 to prevent an overheat phenomenon of the turbine portion 2 of the present invention occurring at the conventional turbine engines and simultaneously regulates rotational torque of the power shaft uniformly to improve rotational features.

The oscillating cam assembly 31 as one of the controlling apparatuses for controlling the piston portion 1 of the piston compressed turbine engine of the present invention includes bearing balls 311 and a piston cam rotor 312, as shown in FIG. 1.

The bearing ball 311 connected to the piston rod 122 of the piston portion 1 and the piston cam rotor 312 connected to the power shaft 21 of the turbine portion 2 convert the rotation of the power shaft 21 into the reciprocation of the piston rod 122 as the power shaft 21 rotates. The bearing ball 311 installed at one end portion of the piston rod 122 has a globular shape to minimize friction generating when it contacts the piston cam rotor 312.

Also, the piston cam rotor 312 has a piston ascending/descending track 313 formed therein along the circumference of the piston cam rotor 312, along which the bearing ball 311 slides by being inserted therein, and a fixing shaft 314 formed at the center of the piston cam rotor 312 and fixing detachably the piston cam rotor 312 to the power shaft 21. That is, the piston cam rotor 312 is a rotary cylinder having the piston ascending/descending track 313 that is a vertically lengthy groove with protrusion and depression into which the piston rod 122 is inserted.

Thus, as the power shaft 21 of the turbine portion 2 rotates, the piston rod 122 can slide and simultaneously ascend/descend along the piston ascending/descending track 313 formed in the piston cam rotor 312 with respect to the cylinder block 11.

Also, the piston cam rotor 312 controls the piston rod 122 to suck air or air-fuel mixture into the cylinder 11a when the piston rod 122 retreats, to compress air or air-fuel mixture when the piston rod 122 advances, and particularly to put pause to the piston head 121 at TDC while the compressed air-fuel mixture explodes and high-pressure combustion gas is injected toward the impeller 22 and exhausted outside.

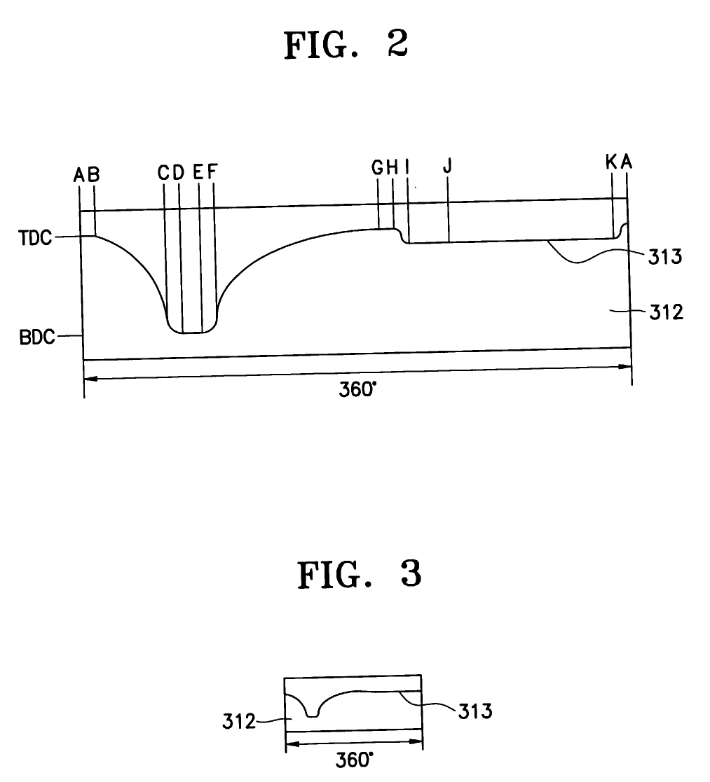

That is, as shown in FIG. 2, the piston ascending/descending track 313 includes a retreat section B-D in which air or air-fuel mixture is drew into the cylinder 11a as the piston 12 retreats, a pause-at-BDC section D-E in which the piston 12 pauses at BDC for a predetermined time until the intake delay due to inertia of the inducted air or air fuel mixture is removed, an advancing section E-G in which the sucked air or air-fuel mixture is compressed as the piston 12 advances, and a pause-at-TDC section G-B in which the piston 12 pauses at TDC for a predetermined time. While the piston 12 pauses at TDC, constant-volume combustion is performed during an combustion section I-J, and after the combustion is completed the combustion gas rotates the impeller and is exhausted during an expansion/exhaust section J-K.

Each of the sections is designed to operate optimally at the feature of an intake process, a compression process, a combustion process, and an expansion/exhaust process. For example, the height between protrusion and depression of the piston ascending/descending track determines stroke distance of the piston 12. The circumferential length of each of the sections of the piston ascending/descending track 313 determines the duration for which the piston 12 moves or pauses. The inclination of the piston ascending/descending track 313 determines the velocity of the piston 12.

Also, as shown in FIG. 2, in the piston ascending/descending track 313, the boundary of each section is chamfered as round and inclination of the track of each section is designed to increase the velocity of the piston 12 at the retreat section B-C and to decrease gradually the velocity of the piston 12 at the advancing section F-G. to minimize an impact by inertia, pressure and friction applied to the piston portion 1 and the controlling apparatus 3.

Also, as shown in FIG. 2, in the pause-at-TDC section G-B of the piston ascending/descending track 313, preferably, the upper surface of the piston head 121 is paused at the TDC and contacted without gap with the inner surface of the cylinder block 11 facing the piston head 121. Then, an area of the piston head 121, to which a high pressure of the combustion gas occurring in the combustion chamber 113 during the combustion and expansion/exhaust process is applied, is minimized, and a total pressure applied to the piston head 121 is minimized. And the heat of the piston head 121 is transmitted through a contact surface between the inner surface of the cylinder block 11 facing the piston head 121 and the upper surface of the piston head 121 to the cylinder block 11 maintained at a relatively lower temperature by the cooling apparatus, and the piston head 121 can be cooled efficiently.

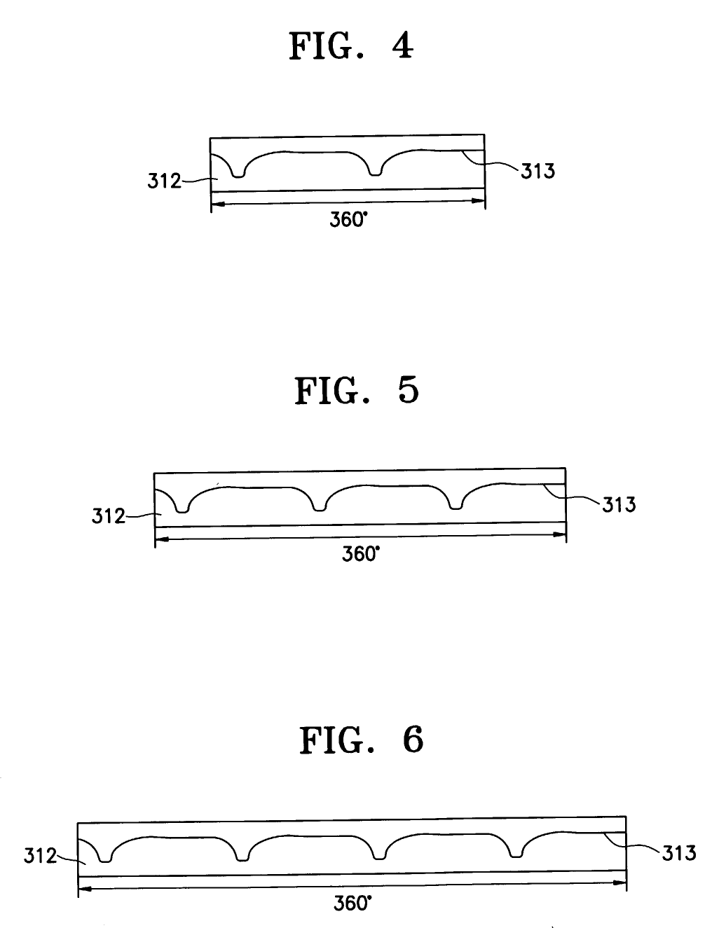

As shown in FIGS. 2 and 3, in the piston ascending/descending track 313, a cycle including the retreat section, the pause-at-BDC section, the advancing section, and the pause-at-TDC section can be repeated one time throughout the entire circumference (360°) of the piston cam rotor 312. But, as shown in FIGS. 4, 5, and 6, in which the cycle is repeated two times, three times, and four times, respectively, the piston ascending/descending track 313 can be formed in the piston cam rotor 312 such that the cycle can be repeated N times so that combustion is performed N times when the power shaft 21 of the turbine portion 2 rotates one turn by 360°(two times in FIG. 4, three times in FIG. 5, and four time in FIG. 6), and a power shaft output of an engine can be adjusted during one turn of the power shaft 21.

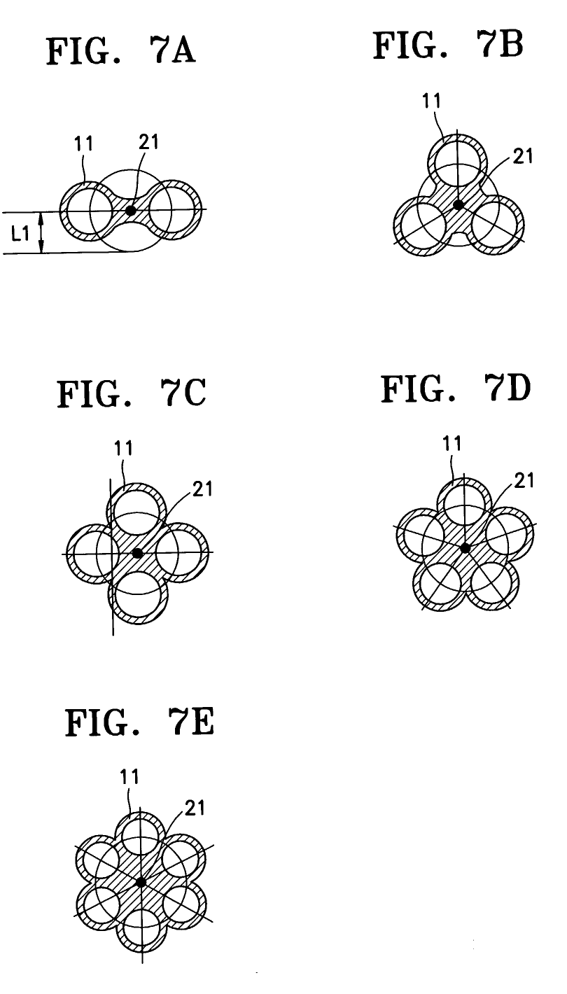

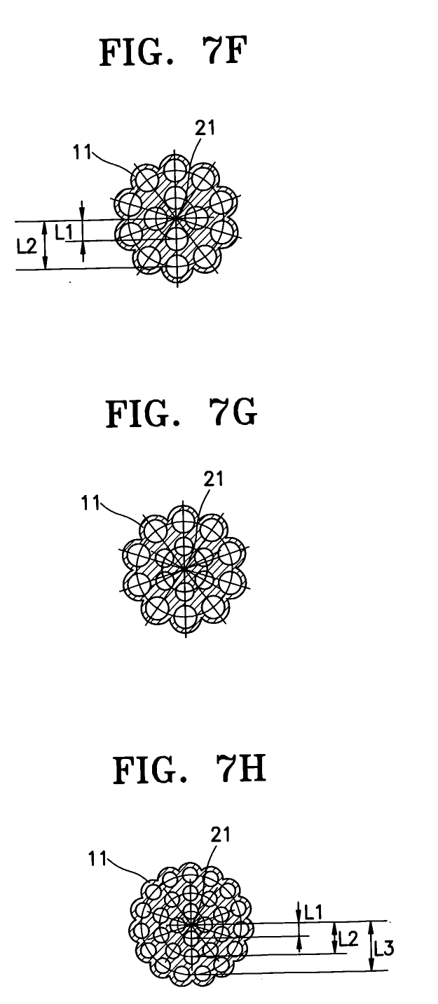

Thus, it is easy to manipulate the number of power generation process at each cylinder 11a and rotational torque of the power shaft 21 during one rotation of the power shaft 21. So great power can be obtained with a small apparatus without restriction of various decelerating apparatuses. In addition, apart from the repetition of the cycle of the piston ascending/descending track 313, as shown in FIGS. 7A through 7E, the cylinder block 11 of the piston portion 1 can be manufactured into various types such as a two-cylinder type (FIG. 7A), a three-cylinder type (FIG. 7B), a four-cylinder type (FIG. 7C), a five-cylinder type (FIG. 7D), and a six-cylinder type (FIG. 7E). The availability of various power generation angle of the power shaft 21 can result in greater output power generated from a small and light cylinder block.

In the cylinder blocks, plural cylinders are arranged parallel to one another in a single tier at the circumference of a circle of radius L1 with an identical angle around the power shaft 21 of the turbine portion 2, as shown in FIGS. 7A through 7E. Also, as shown in FIGS. 7F and 7G, to increase the output of the engine, cylinders can be arranged in double tiers at the circumferences of circles of radius L1 and L2 around the power shaft 21 of the turbine portion.

Here, FIG. 7F shows a 14-cylinder type engine in which four cylinders are arranged in the inner tier and ten cylinders are arranged in the outer tier. FIG. 7G shows a 16-cylinder type engine in which six cylinders are arranged in the inner tier and ten cylinders are arranged in the outer tier. As shown in FIG. 7H, cylinders can be arranged at a distance L3 in triple tiers in which four cylinders are arranged in the inner tier, ten cylinders are arranged in the middle tier, and fifteen cylinders are arranged in the outer tier, forming a 29-cylidner type engine. It is obvious that cylinders can be arranged in N tiers.

Thus, the possibility to compact size of an engine, the variety of possible arrangements and the maximization of the output torque of the engine prove that the piston compressed turbine engine according to the present invention can be effectively used in all fields of engines such as airplanes, automobiles, and high output engines. In particular, the above advantages may greatly contribute to the lightness of an engine according to improvement of gas mileage and performance as well as the smoke regulations which have been accentuated recently.

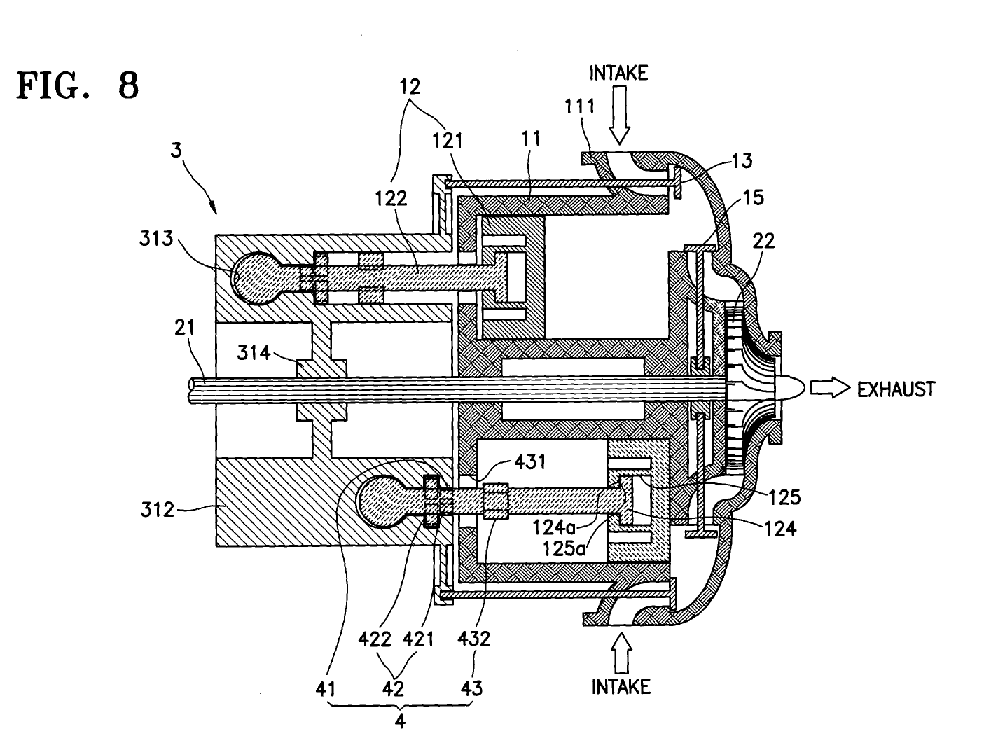

As shown in FIG. 8, a piston compressed turbine engine according to another preferred embodiment of the present invention, unlike the smooth shaped piston rod 122 shown in FIG. 1, a piston rod locking apparatus 4 is further provided at the middle of the piston rod 122. The piston rod locking apparatus 4 rotates sporadically the piston rod 122 axially at the predetermined time, and enables or disables the piston rod 122 to move. After the compression is finished, the piston rod 122 is locked to the cylinder block 11 to prevent the transmission of the pressure applied to the piston 12 by combustion gas to the piston cam rotor 312 of the controlling apparatus 3 during the combustion and expansion/exhaust process. After the exhaust is completed, the piston rod 122 is released again from the cylinder block 11, and enabled to move for the air or air-fuel mixture intake/compression. And as the piston rod 122 axially rotates, the piston head 121 axially rotates at the beginning of the retreat section to facilitate even cooling of the piston head 121. That is, as shown in FIG. 8, the piston rod locking apparatus 4 includes rod-rotating guides 41, rod-rotating protrusion 42, and a rod-locking protrusion 43.

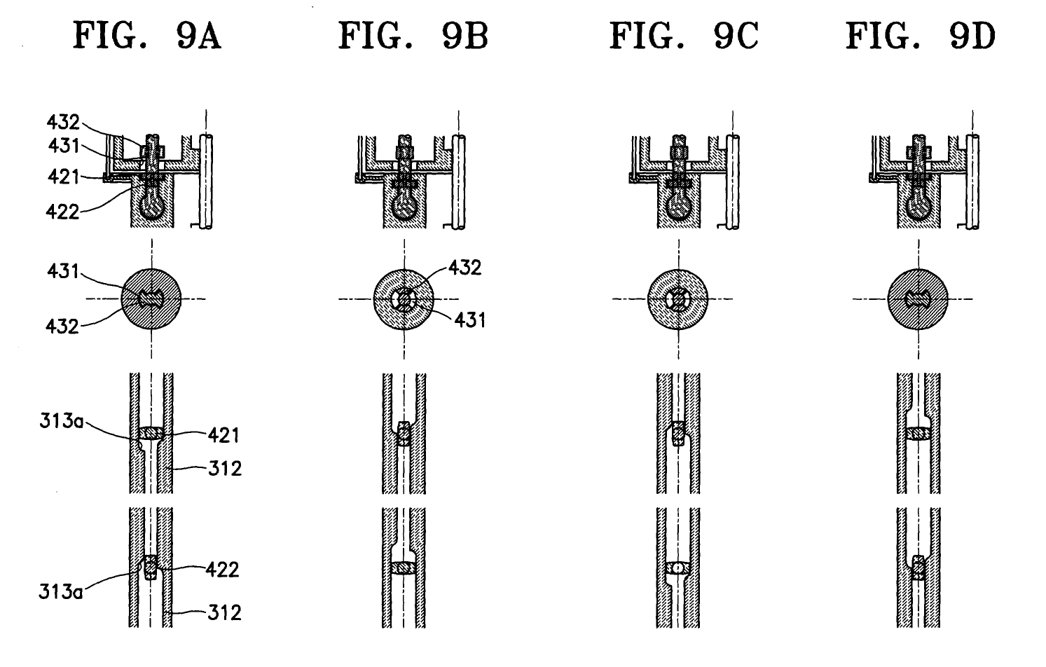

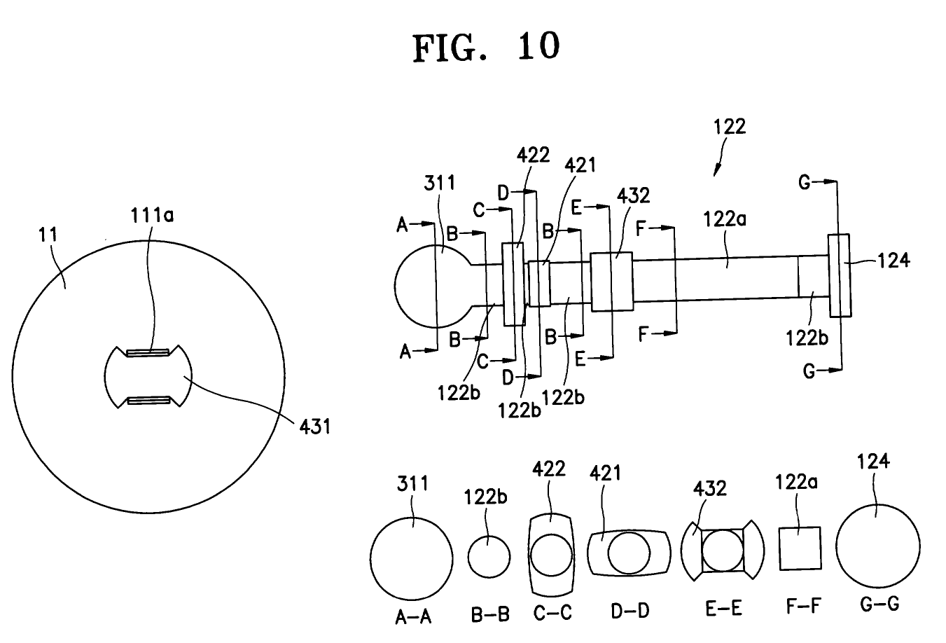

Here, as shown in FIGS. 9A through 9D, the rod-rotating guides 41 are composed of guiding protrusions 313a sporadically formed at each side wall of the piston ascending/descending track 313 to guide the sporadic axial rotation of the piston rod 122, incorporating into the piston cam rotor 312. Also, as shown in FIGS. 9A through 9D and 10, the rod-rotating protrusion 42 protruding at the middle of the piston rod 122 and integrally formed with the piston rod 122 is inserted in the piston ascending/descending track 313 corresponding to the double line type guiding protrusions 313a of the piston cam rotor 312, and rotates the piston rod 122 in the axial direction as the rod-rotating protrusion 42 is twisted by the double line type guiding protrusions 313a. Preferably, the rod-rotating protrusion 42 includes a locking-rotation protrusion 421 formed at the middle of the piston rod 122 and a releasing-rotation protrusion 422 formed at the bearing-ball side tip of the piston rod 122.

Also, the rod-locking protrusion 43 protruding at the middle of the piston rod 122 and integrally formed with the piston rod 122 has a shape corresponding to a rod-guiding window 431 formed in the lower surface of the cylinder block 11. The rod-locking protrusion 43 is selectively enabled or disabled to move through the rod-guiding window 431 according to the rotation angle of the piston rod 122. Preferably, the rod-locking protrusion 43 is formed including a butterfly shaped protrusion 432 whose both sides protrude like a butterfly shape.

Here, to prevent rotation of the piston rod 122 for a predetermined period, the piston rod 122 has a polygonal portion 122a with a section corresponding to a polygonal hole (bearings 111a are installed at the contacting surface to the piston rod 122 to facilitate sliding of the piston rod 122 through the rod-guiding window 431) formed at the cylinder block 11. The polygonal portion 122a prevents unnecessary rotation of the piston rod 122 during the reciprocation so that the rod-locking protrusion 43 can pass through the rod-guiding window 431, and improves the linear movement of the piston rod 122.

Also, a cylindrical portion 122b is formed at both end portions of the polygonal portion 122a of the piston rod 122 so that, after the compression or exhaust completed, the piston rod 122 can rotate freely.

Thus, as shown in FIGS. 9A through 9B, as the compression is completed, the piston rod 122 reaches at the pause-at-TDC state (G of FIG. 2), the locking-rotation protrusion 421 of the rod-rotating protrusion 42 formed at the middle of the piston rod 122 is rotated by 90° through the steps (a)-(b) by the guiding protrusions 313a of the rod-rotating guide 41. Then, the butterfly shaped protrusion 432 formed on the piston rod 122 is rotated and the butterfly shaped protrusion 432 cannot pass through the rod-guiding window 431 of the cylinder block 11(H of FIG. 2). Thus, the piston rod 122 can be locked to the cylinder block 11 and fixed thereby. As shown in FIGS. 9C through 9D, when the exhaust is completed (A of FIG. 2), the releasing-rotation protrusion 422 of the rod-rotating protrusion 42 formed at the bearing-ball side tip of the piston rod 122 undergoes the step (c)-(d) by the guiding protrusion 313a of the rod-rotating guide 41 and rotates again by 90° (totally 180°). Then, the piston rod 122 is rotated again so that the butterfly shaped protrusion 432 formed at the piston rod 122 can pass through the rod-guiding window 431 of the cylinder block 11. Thus, the piston rod 122 can reciprocate, not being blocked by the cylinder block 11 (B of FIG. 2). (In FIGS. 9A through 9D, for the convenience of explanation, sectional and plan views of the locking and releasing state between the rod-guiding window 431 and the butterfly shaped protrusion 432 and plan views of the locking-rotation protrusion 421 or the releasing-rotation protrusion 422 rotating as being twisted by the rod-rotating guide 41 are shown from up to down for each of the steps (a), (b), (c), and (d), and the rotating direction of the piston cam rotor 312 at which the rod-rotating guide 41 is installed is supposed as upward.)

Also, as shown in FIG. 2, the piston ascending/descending track 313 of the pause-at-TDC section I-K during the explosion and exhaust process is preferably slightly lower than the highest point of the piston ascending/descending track 313, that is, the piston ascending/descending track 313 of the compression completion point (G of FIG. 2) and the intake start point (B of FIG. 2). Then, when the piston rod 122 is locked to the cylinder block 11 and fixed thereby, the piston rod 122 does not contact with the piston cam rotor 312. Thus, transmission of a shock to the piston cam rotor 312 by the pressure of the combustion gas during the combustion and expansion/exhaust process can be prevented.

That is, if the high pressure applied to the piston head 121 by the combustion gas during the combustion and expansion/exhaust process is directly transmitted to the piston cam rotor 312, the rotation of the power shaft 21 is prevented and severe impacts are applied to parts. To prevent the above obstruction and impacts, the piston rod locking apparatus 4 temporarily locks the piston rod 122 to the cylinder block 11 so that the pressure applied to the piston head 121 is transmitted to the cylinder block 11 that is relatively durable.

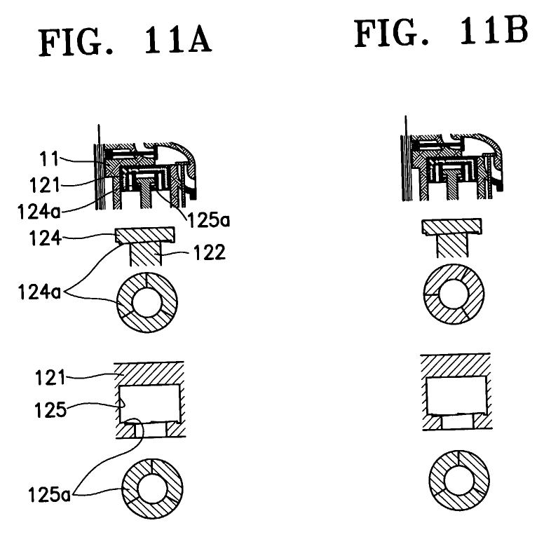

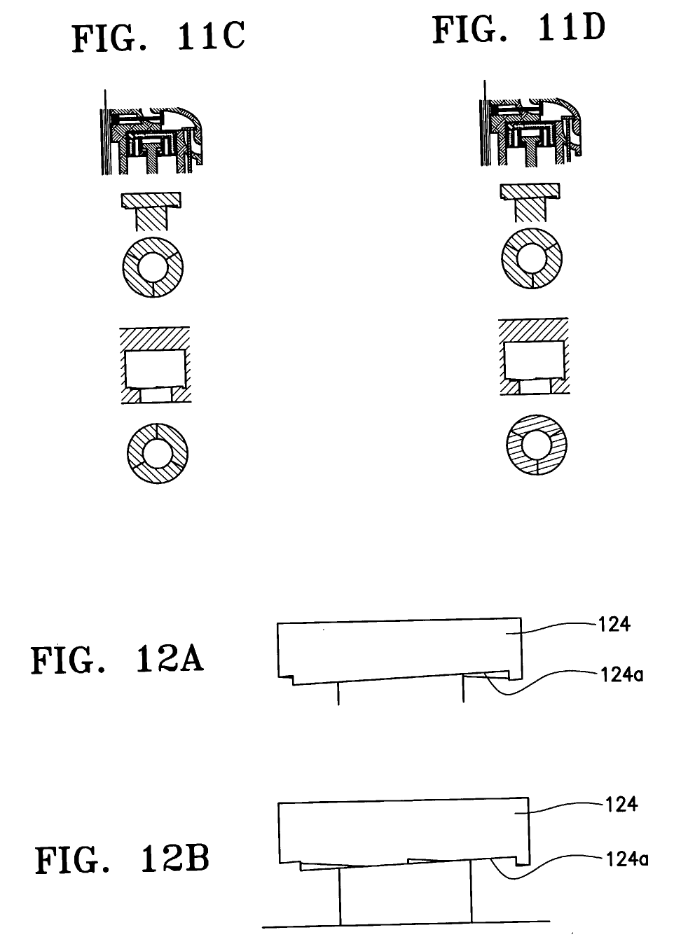

In the meantime, as shown in FIGS. 11A through 11D, the piston head 121 of the present invention which is exposed to the high temperature combustion gas can be cooled by contacting the upper surface of the piston head 121 and the inner surface of the cylinder block 11 facing at the piston head when the piston 12 is in the pause-at-TDC state (G-B of FIG. 2). Furthermore, to evenly cool the piston head 121 by rotating the piston head 121 by predetermined angle at every operation cycle and gradually changing heating area of the piston head 121 which contacts high temperature combustion chamber and cooling area of the piston head 121 which contacts relatively low temperature cylinder block, an inner piston 124 at the piston rod side and an inner cylinder 125 at the piston head side are arranged, and toothed surfaces 124a and 125a with one-way rotational incline which are facing each other and geared into each other when contacting are formed at the bottom surfaces of the inner piston 124 and the inner cylinder 125. When the piston rod 122 rotates by 180° through the steps of FIGS.11A through 11D, the piston head 121 rotates by a predetermined angle depending on the number of the toothed surfaces 124a and 125a. As shown in FIGS. 11A through 11D, when the number of the toothed surfaces 124a and 125a is 3, the angle of rotation of the piston head 121 is 60°.

That is, as shown in FIGS. 11A through 11D, when the compression is completed and the piston rod 122 reaches the pause-at-TDC state (G of FIG. 2), the toothed surfaces 124a and 125a are completely separated from each other (FIG. 11A). The locking-rotation protrusion 421 of rod-rotating protrusion 42 formed at the middle of the piston rod 122 is rotated by 90° by the guiding protrusions 313a of the rod-rotating guide 41 at the piston cam rotor 312, and the toothed surfaces 124a formed on the bottom of the inner piston 124 rotates by 90° simultaneously (FIG. 11B). At the completion of exhaust (A of FIG. 2), the releasing-rotation protrusion 422 of the rod-rotating protrusion 42 formed at the bearing-ball side tip of the piston rod 122 is rotated by 90° by the guiding protrusion 313a of the rod-rotating guide 41 at the piston cam rotor 312, and also the toothed surfaces 124a formed on the bottom of the inner piston 124 rotates by 90° (a total of 180°) so that the angles of the toothed surfaces 124a and 125a are deviated by 60° (FIG. 11C). When the piston rod 122 begins to retreat from the pause-at-TDC state (B of FIG. 2), the inner piston 124 descends first and contacts the inner cylinder 125. Here, the toothed surface 124a of the inner piston 124 contacts the toothed surface 125a of the inner cylinder 125 and the toothed surface 125a slides to be perfectly aligned with respect to the toothed surface 124a. Thus, the piston head 121, where the inner cylinder 125 is formed, also rotates by a predetermined angle (FIG. 11D). In FIGS. 11A through 11D, the shapes of the inclined surfaces of the inner piston and the inner cylinder are shown from up to down step by step for the convenience of explanation. In FIGS. 12A and 12B, the side views of the inner piston before and after rotation are shown in detail.

That is, for example, whenever the piston head 121 performs an intake stroke, the toothed surface 125a of the inner cylinder 125 of the piston head 121 rotates by 60°. The area of the piston head 121, which is exposed to the combustion chamber 113 and heated by the combustion gas to a high temperature, rotates 60° and contacts the inner surface of the cylinder 11a which is relatively cold at the next operation cycle. As the above process is repeated, the entire surface of the piston head 121 contacts the inner surface of the cylinder 11a, so that cooling can be made evenly and entirely. Here, since an engine cooling system for cooling the surface of the cylinder 11a is a well-known technology, a description thereof will be omitted.

In addition to the method to rotate the piston head 121 by the toothed surfaces 125a of the inner cylinder 125 of the piston head 121 and the toothed surface 124a of the inner piston 124 of the piston rod 122 as described above, odd numbers of protrusions at the side wall of the inner piston 124 and the same number of straight grooves and twisted grooves at the side wall of the inner cylinder 125 can be arranged to rotate the piston head 121. The protrusions are arranged at a circumference around the side wall of the inner piston 124 with an identical angle, and straight grooves are arranged vertically at the circumference around the side wall of the inner cylinder 125 with an identical angle and twisted grooves are formed at the circumference around the side wall of the inner cylinder 125 from the top center of two straight grooves to the bottom of one of the two straight grooves, respectively. Then, when the piston rod 122 moves toward the TDC, the protrusions of the inner piston 124 move through the straight grooves of the inner cylinder 125. When the piston rod 122 moves toward the BDC after the piston rod 122 rotates by 180°, the protrusions of the inner piston 124 move through the twisted grooves of the inner cylinder 125, and the piston head 121 rotates by a predetermined angle corresponding to the numbers of the protrusions and grooves.

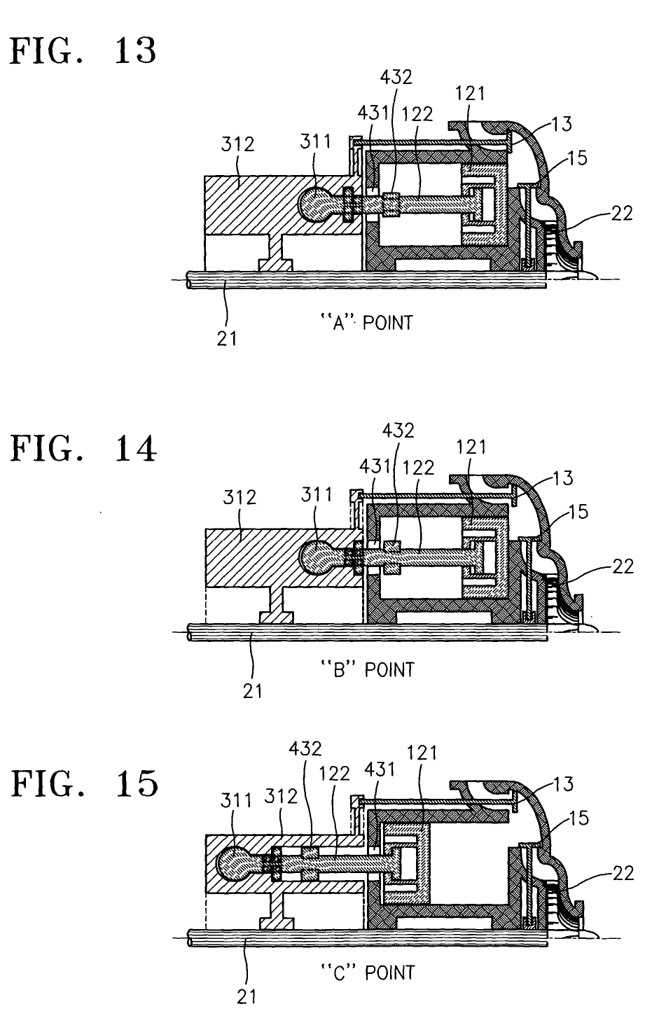

Thus, the cooling method by the piston head rotation in the present invention is quite different from the cooling method of the conventional piston engine, in which the rotation of the piston head is not possible, and is a new technology to minimize the heat burden acting on the piston head. The operation cycle of the piston compressed turbine engine of the present invention is as follows. As shown in FIG. 13 (“A” point of FIG. 2) through FIG. 14 (“B” point of FIG. 2), when the exhaust valve 15 is closed as the exhaust of combustion gas is completed, the piston rod 122 rotates by 90° so that the butterfly shaped protrusion 432 can move through the rod-guiding window 431 and the piston rod 122 is in a state capable of reciprocation. Simultaneously, the intake valve 13 is open. As shown in FIG. 14 (“B” point of FIG. 2) through FIG. 15 (“C” point of FIG. 2), as the power shaft 21 rotates, the bearing ball 311 of the piston rod 122 slides along the piston ascending/descending track 313 of the piston cam rotor 312 so that the piston head 121 retreats and air or air-fuel mixture is sucked into the cylinder 11a. At the same time, through the steps of FIGS. 11C-11D, the piston head 121 rotates by 60° as the toothed surface 124a of the inner piston 124 contacts the toothed surface 125a of the inner cylinder 125.

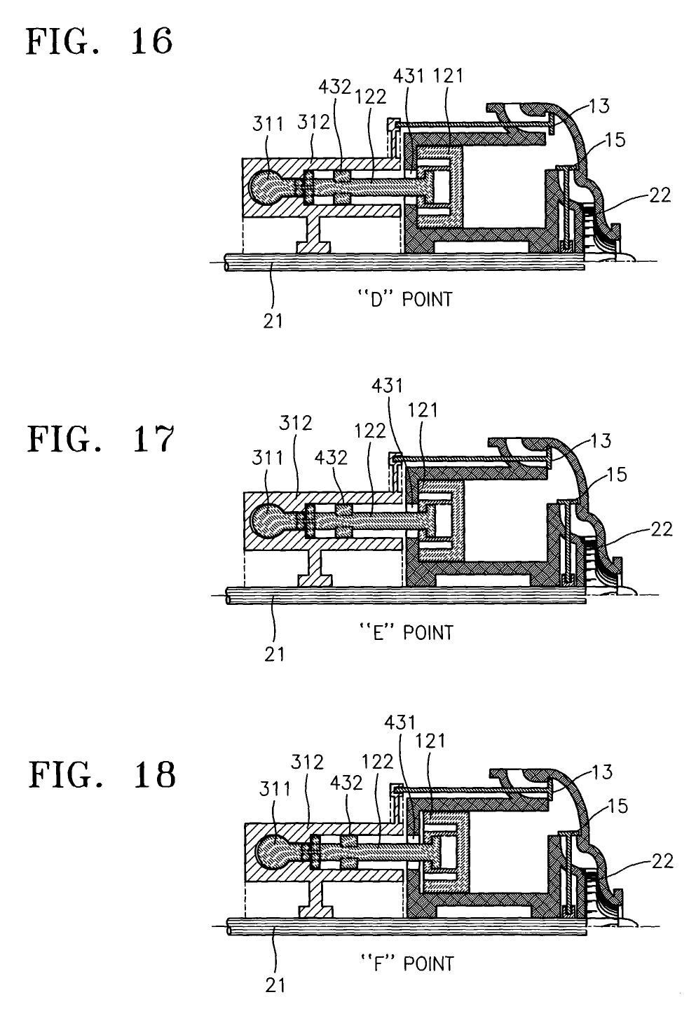

Next, as shown in FIG. 15 (“C” point of FIG. 2) through FIG. 16 (“D” point of FIG. 2), as the piston 12 approaches the BDC, the speed of the piston rod 122 gradually decreases to reduce the inertia of the piston 12. As shown in FIG. 16 (“D” point of FIG. 2), when the piston 12 reaches the BDC, the piston 12 is paused for a predetermined time (a section between “D” point and “E” point of FIG. 2) to relieve the delay in intake caused by the inertia of the air or air-fuel mixture. As shown in FIG. 17 (“E” point of FIG. 2), as the intake valve 13 is closed, the intake stroke is completed.

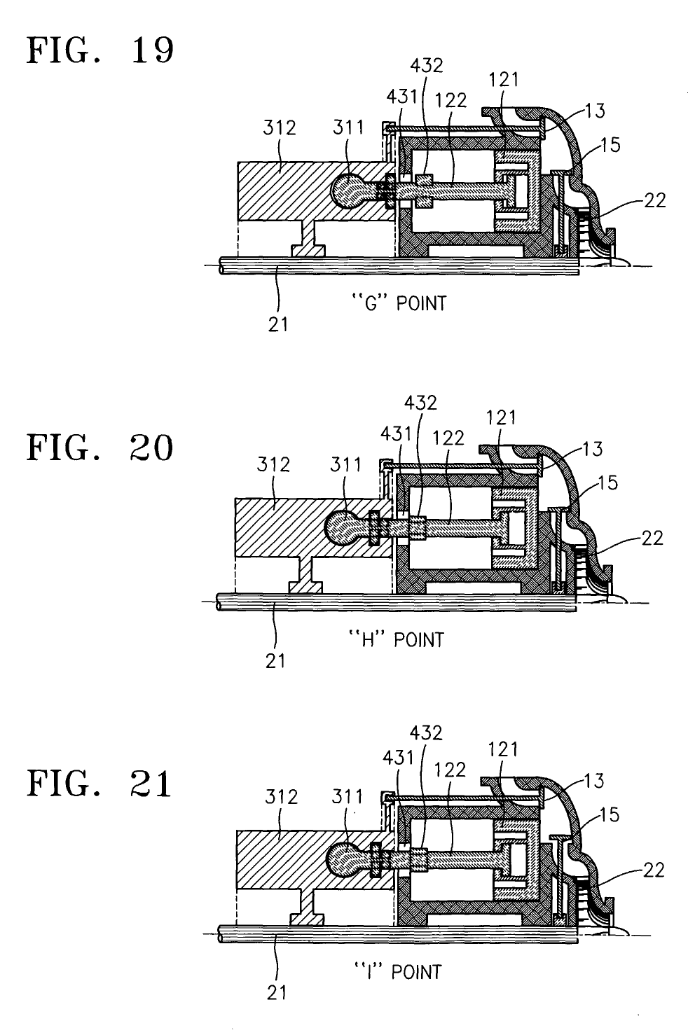

Next, as shown in FIG. 17 (“E” point of FIG. 2) through FIG. 18 (“F” point of FIG. 2), the piston 12 advances in the direction opposite to the direction in the case of intake stroke. Here, the speed of the piston 12 is gradually increased to compensate for the inertia of the piston 12. As shown in FIG. 18 (“F” point of FIG. 2) through FIG. 19 (“G” point of FIG. 2), the speed of the piston 12 is gradually decreased as the compression stroke proceeds. When the compression of the air or air-fuel mixture is completed, as shown in FIG. 19 (“G” point of FIG. 2) through FIG. 20 (“H” point of FIG. 2), the piston rod 122 rotates by 90°. As shown in FIG. 20 (“H” point of FIG. 2) through FIG. 21 (“I” point of FIG. 2), the piston rod 122 is locked to the cylinder block 11 and does not contact the piston cam rotor 312.

Next, as shown in FIG. 21 (a section between “I” point to “J” point of FIG. 2), the compressed air-fuel mixture is ignited by an ignition plug or fuel is injected into the compressed air and spontaneously ignited by the compression heat of air, and combustion proceeds.

Here, since the piston 12 does not move at the TDC during the combustion, constant volume combustion is executed, and the temperature and pressure of the combustion chamber sharply increases. However, this pressure is applied to the cylinder block 11 through the piston rod 122, but not to the piston cam rotor 312, so that there is no frictional loss between the piston rod 122 and the piston cam rotor 312 due to the pressure of the combustion gas.

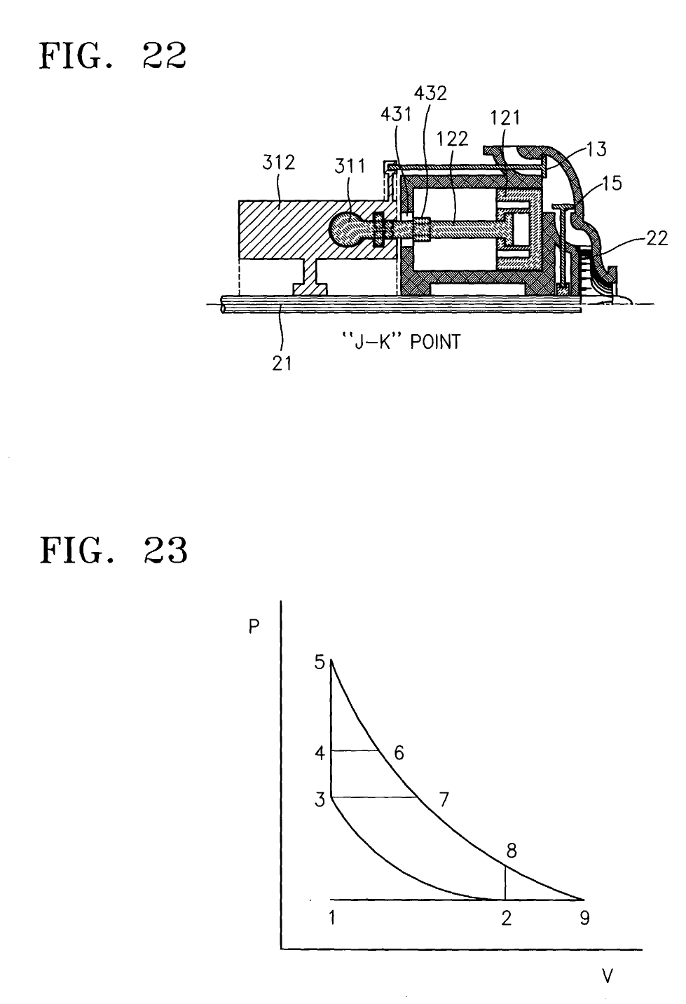

Next, when the combustion is completed, as shown in FIG. 22 (a section between “J” point to “K” point of FIG. 2), the exhaust valve 15 is open and a high-temperature and high-pressure combustion gas rotates the impeller 22 of the turbine portion 2 connected to the exhaust manifold 112. Thus, rotational power is generated and then the combustion gas is exhausted outside the engine.

When the combustion gas is completely exhausted from the combustion chamber, as shown in FIG. 22 (“K” point of FIG. 2) through FIGS. 13 (“A” point of FIG. 2), as the piston rod 122 is separated from the cylinder block 11, the exhaust valve 15 is closed. This concludes the power generating cycle, that is, operation cycle and the above steps are repeated.

In the piston compressed turbine engine of the present invention, the open and close duration for the intake valve 13 and the exhaust valve 15 and the time to start combustion can be modified and changed corresponding to the shape of the piston ascending/descending track 313 within the technical concept of the present invention.

An auxiliary compression cylinder, which blows the compressed air during the late section of expansion process to the heated impeller 22 by the combustion gas, can be installed to cool the turbine portion down and to help the exhaust of the combustion gas in the combustion chamber by the Bernoulli-effect.

Here, in FIG. 22, during the expansion and exhaust processes, the piston rod 122 pauses at the TDC, and power is generated. So these steps can be referred to as a power process.

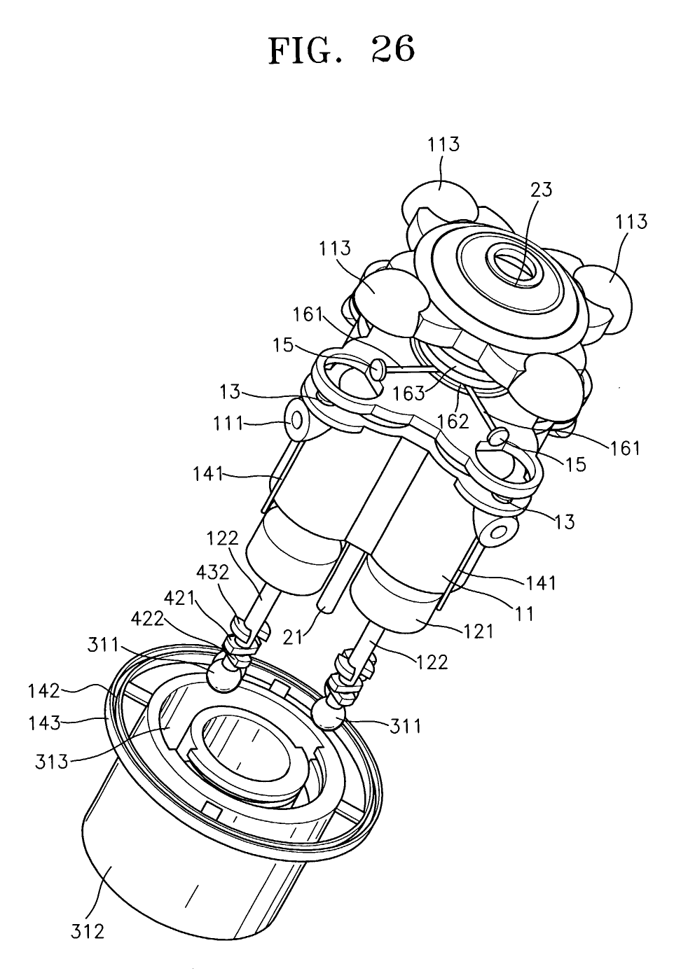

The piston compressed turbine engine of the present inventions can be modified and changed within the technical concept of the present invention. FIG. 25 is a partially cut-away perspective view of a variation of preferred embodiments of the present invention which is shown in FIG. 1. Also, FIG. 26 is an exploded perspective view of an example of the preferred embodiments of the present invention shown in FIG. 8.

As shown in FIGS. 25 and 26, in the piston compressed turbine engine of the present invention, a compact engine can be manufactured with very simple parts without additional crank mechanism or joint mechanism. Also, output power, efficiency and gas mileage are remarkably higher than conventional engines due to constant-volume combustion, and polluting smoke generated due to the delay of combustion can be reduced. Further, because pressure applied to the piston does not transmitted to the mechanism moving and has no joint movement by the piston, the piston compressed turbine engine can operate at low noise and low vibrations and has superior durability, and the applicability and adaptability of design according to the torque and output power are very high.

In the piston compressed turbine engine of the present invention, theoretically the output power can be increased unlimitedly by connecting several engines. So the limited space of an engine room can be efficiently utilized, and the number of parts needed for the connection of the engines can be minimized.

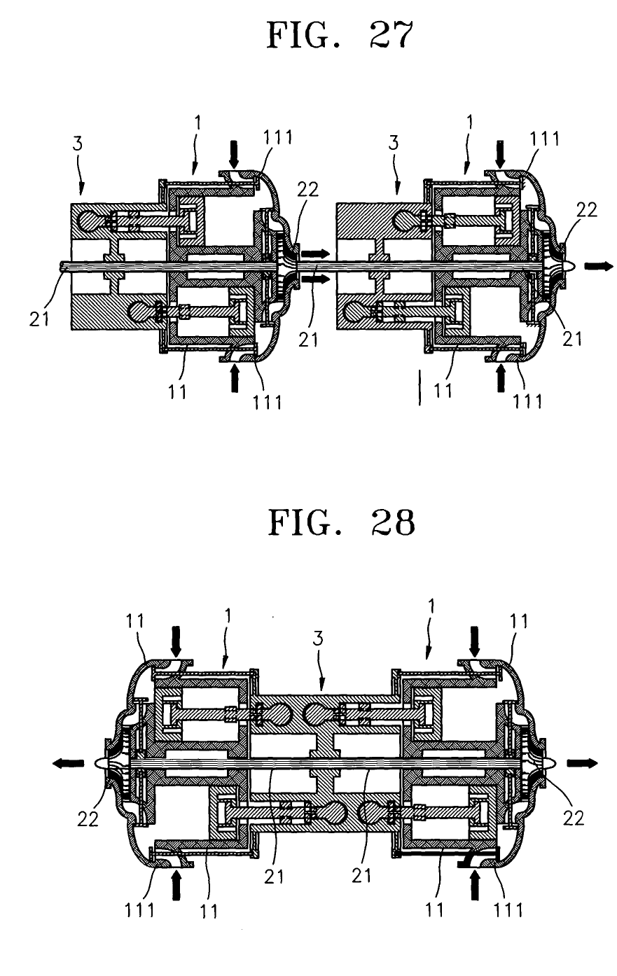

That is, as shown in FIG. 27, to connect one set of a piston compressed turbine engine of the present invention, including the piston portion 1, the turbine portion 2, and the controlling apparatus 3, and another set of the engine, the power shafts 21 from the two engines can be manufactured integrally or connected by an additional connecting unit. The respective sets can be arranged to face the same direction, and the power shafts 21 of N-numbered sets can be connected in series to increase the output power of the power shaft 21.

As shown in FIG. 28, in addition to the above series type connection, to connect one set of a piston compressed turbine engine of the present invention including the piston portion 1, the turbine portion 2, and the controlling apparatus 3 and another set of the engine arranged in the opposite direction, the controlling apparatus 3 of each set can be connected to face each other forming an opposed type controlling apparatus 3.

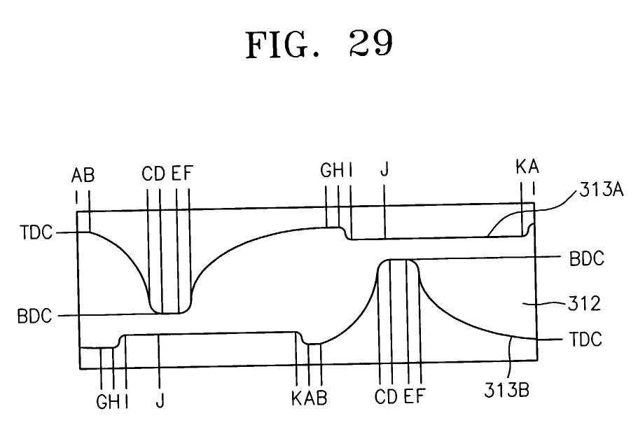

As shown in FIG. 29, the controlling apparatus 3 of the piston compressed turbine engine connected in an opposed type is composed of a double opposed type track (a forward direction ascending/descending track 313A and a reverse direction ascending/descending track 313B) in a reverse symmetry. The tracks are formed in the piston cam rotor of an oscillating cam assembly for ascending/descending the piston of the piston portion 1. Thus, the pistons of the respective sets are installed not in a surface symmetry but in a point symmetry with respect to the opposed type controlling apparatus 3 and reciprocate.

Here, although not shown in the drawing, N-numbered sets of opposed type can be connected in series by the common power shaft 21. Therefore, in the piston compressed turbine engine of the present invention, unlike the conventional engines, the effect by an impact or vibrations applied to the power shaft is reduced and the power shaft, the cylinder, and the piston are arranged in parallel, forming a parallel shaft arrangement structure. Thus, numbers of engines can be easily and freely connected into the series type or opposed type. So the piston compressed turbine engine of the present invention can be widely used in a variety of places where high performance engines are needed.

The thermal conversion efficiency of the piston compressed turbine engine of the present invention can be easily understood by comparing the performance and efficiency of the conventional piston engine and the turbine engine with those of the present invention. In review of the thermodynamic performance of the engine, to check gas standard cycle is a basic item. FIG. 23 shows an ideal gas standard cycle of each engine. In FIG. 23, horizontal lines indicate constant pressure lines, vertical lines indicate constant volume lines, and arc lines indicate an adiabatic compression line and an adiabatic expansion line.

Here, 1-2-3-5-8-2-1 indicates Otto cycle, 1-2-3-7-8-2-1 indicates Diesel cycle, 1-2-3-4-6-8-2-1 indicates Sabathe cycle, and 2-3-7-9-2 indicates Turbine cycle whereas the cycle of the piston compressed type turbine engine of the present invention is 1-2-3-5-9-2 showing the largest area of a closed polygon which means the output power of an engine.

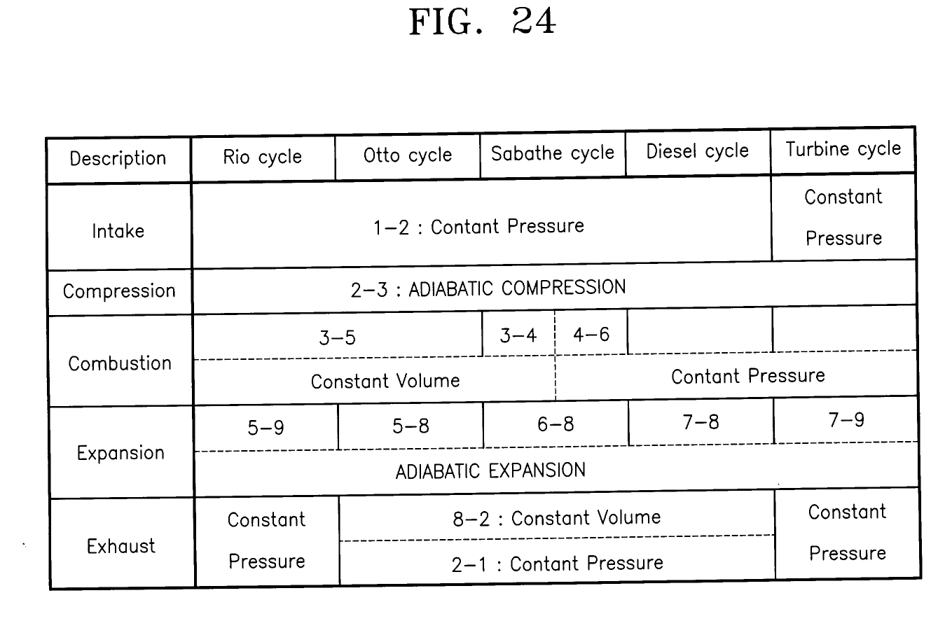

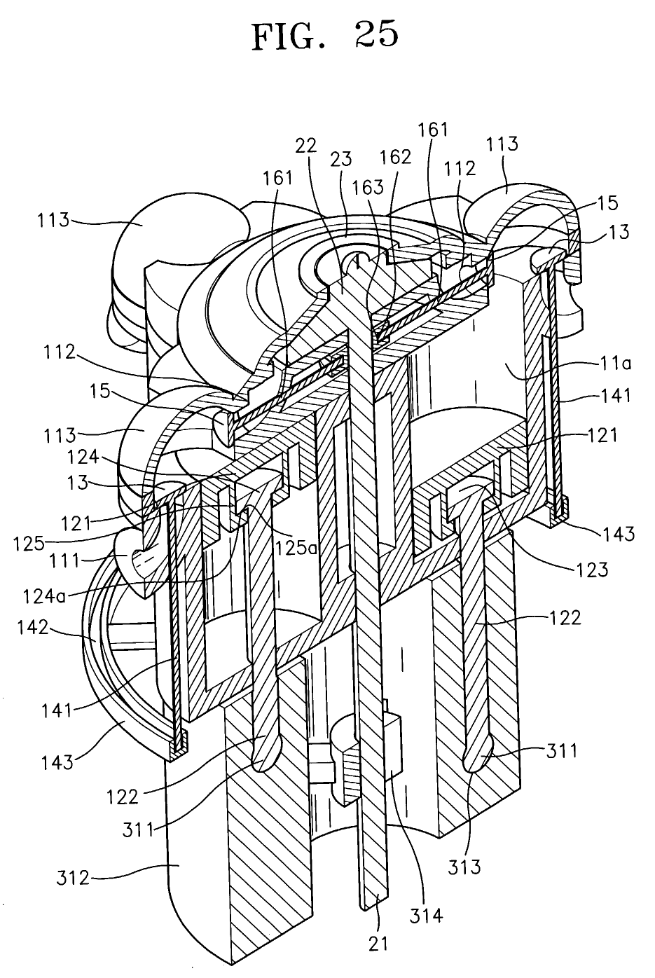

FIG. 24 shows the comparison of characteristics of the respective cycles. In FIG. 24, the cycle of the piston compressed turbine engine of the present invention is indicated by Rio cycle for the convenience of explanation. That is, as in the above-described structure and operational principle, the ideal gas standard cycle of the piston compressed turbine engine of the present invention is similar to the Otto cycle in the intake stroke, the compression stroke, and the combustion process and the Turbine cycle of the turbine engine in the expansion process and the exhaust process.

Adiabatic compression is performed by receiving power from the outside. The power is transferred to the outside during adiabatic expansion. The balance between the power transferred to the outside and the power received from the outside is equivalent to a balance in quantity between heat generated during the combustion process and heat discharged during the exhaust process, which becomes the output of an engine.

The output of the respective engines is proportional to the area of a closed polygon of a gas standard cycle in the P-V diagram of FIG. 23. As shown in the P-V diagram of FIG. 23, it can be seen that constant volume combustion is more efficient than constant pressure combustion and constant pressure exhaust is more efficient than constant volume exhaust.

That is, under the ideal conditions of the respective engines in which the temperature and pressure of intake air, the compression ratio of the engine, and the amount of supplied fuel are identical and the maximum allowable temperature and pressure of the engines and all other losses are ignored, the piston compressed turbine engine of the present invention is most efficient since it can generate the more output power than any other engines through the constant volume combustion and the constant pressure exhaust.

The ideal thermal conversion efficiency of the piston compressed turbine engine of the P-V diagram of FIG. 23 can be obtained as followings. If working fluid in the cylinder is assumed to be ideal gas over a predetermined amount, at each point of consecutive sequence of process;

P2V2=GRT2, P3V3=GRT3, P5V5=GRT5, P9V9=GRT9, or P2V2/T2=P5V5/T5=P5V5/T5=P9V9/T9, [Equation 1]

where respective subscripts denote the points of consecutive sequence of process of the P-V diagram of FIG. 23.

Also, since compression and expansion are assumed to be performed adiabatically and reversibly,

P2V2K=P3V3K, P5V5K=P9V9K, or P3/P2=(V2/V3)K, P5/P9=(V9/V5)K, [Equation 2]

where K is an adiabatic coefficient and K=CP/CV.

Also, since the process 3-5 shown in FIG. 23 is a constant volume process, V3=V5 and since the process 9-2 is a constant pressure process, P2=P9.

P3/P2=εK where ε is a compression ratio and V2/V3=ε, P5/P9=εKσK where σ is a cut off ratio and V9/V2 =σ, and

V9/V5=εσ. [Equation 3]

From Equations 1, 2, and 3,

T3/T2=P3V3/P2V2=(P3/P2)(V3/V2)=(V2/V3)K(V3/V2)=(V2/V3)K−1=εK−1,

T5/T3=P5V5/P3V3=P5/P3=(P9εKσK)/(P2 εK)=σK

T5/T9=P5V5/P9V9=(P5/P9)(V5/V9) =εKσK(V3/V9)=εK−1σK−1

and

T9/T2=P9V9/P2V2=σ.

Q35=GCV(T5-T3) where Q35 is the quantity of heat supplied, and Q92=GCP(T9-T2) where Q92 is the quantity of heat dissipated.

Hence,

ηTH=(Q35-Q92)/Q35=1−Q92/Q35=1−K(T9-T2)/ (T5-T3)=1−K(σ−1)T2/(σK−1)T3=1

$$η TH = ( Q35 - Q92 ) / Q35 = 1 - Q92 / Q35 = 1 - K ( T9 - T2 ) / ( T5 - T3 ) = 1 - K ( σ - 1 ) T2 / ( σ K - 1 ) T3 = 1 - \{ \frac{K ( σ - 1 )}{{σ}^{K} - 1} \} \frac{1}{{ϵ}^{K - 1}} ,$$

where ηTH is ideal thermal conversion efficiency of the cycle.

In the meantime, the ideal thermal conversion efficiency of the conventional Otto engine is

$$1 - \frac{1}{{ϵ}^{K - 1}}$$

and the ideal thermal conversion efficiency of the conventional Diesel engine is 1

$$1 - \{ \frac{{σ}^{K} - 1}{K ( σ - 1 )} \} \frac{1}{{ϵ}^{K - 1}} \cdot \{ \frac{K ( σ - 1 )}{{σ}^{K} - 1} \}$$

is always smaller than 1 and

$$\{ \frac{{σ}^{K} - 1}{K ( σ - 1 )} \}$$

is always greater than 1. Thus, in case that the compression ratios ε of the engines are same, the efficiency becomes higher in an order of Diesel engine, Otto engine, and the piston compressed turbine engine of the present invention.

However, in case of real engines, the compression ratio of the spark ignition type engine, that is, Otto engine, is maintained in the range of 6-9:1 and that of the compression ignition type engine, that is, Diesel engine, is maintained in the range of 12-25:1 in accordance with the structural and operational features of the respective engines. As shown in the above mentioned formulas of the ideal thermal conversion efficiency of the respective engines, the ideal thermal conversion efficiency increases as

$$\frac{1}{{ϵ}^{κ - 1}}$$

decreases, that is, the compression ratio increases. So the ideal thermal conversion efficiency of Diesel engine is higher than that of Otto engine in the range of the compression ratio of real engines. As mentioned above in the operational features, the piston compressed turbine engine of the present invention can be operated by either spark ignition type or compression ignition type. So the ideal thermal conversion efficiency of real engines becomes higher in an order of that of the Otto engine, that of the spark ignition type piston compressed turbine engine of the present invention in which the compression ratio is in the range of 6-9:1, that of the Diesel engine, and that of the compression ignition type piston compressed turbine engine of the present invention in which the compression ratio is in the range of 12-25:1.

In the meantime, the thermal conversion efficiency of real engines is lowered than an ideal value for inevitable structural and operational reasons. However, the piston compressed turbine engine of the present invention can fundamentally solve the following problems which cannot be solved in the conventional piston engines.

(1) Heat loss due to finite combustion time

A predetermined period of time is needed to generate heat after the ignition of air-fuel mixture, since the combustion is proceeded as flame is propagated through the air-fuel mixture. In the conventional piston engine, the ignition is set to occur shortly before the top dead center (TDC) and the combustion is finished after passing TDC. Accordingly, the maximum pressure is lowered than ideal gas standard cycle and heat is generated during the expansion stroke, and these cause heat loss.

In contrast, in the piston compressed turbine engine of the present invention, since the engine is ignited after the piston reaches TDC, and the piston is paused at the TDC during combustion is proceeded, the maximum pressure is close to the ideal gas standard cycle. After combustion is completely finished, the exhaust valve is open and the expansion and power process begins so that heat loss is reduced.

(2) Heat transfer and loss to the cylinder walls

In the conventional piston engine, since a high temperature combustion gases contact the inside walls of the combustion chamber, the cylinder walls, and the entire surface of the piston head, the peak temperature and pressure are lowered than isentropic expansion so that considerable heat loss take place and this heat loss is related to cooling burden.

However, since the portion of the piston compressed turbine engine of the present invention contacting high temperature combustion gases is limited to the inside walls of combustion chamber and partial part of the piston head, the piston compressed turbine engine of the present invention is more efficient than the conventional piston engines as much as the heat loss to the cylinder walls of conventional engines and the cooling burden is decreased.

(3) Exhaust blow-down loss

In the conventional piston engine, a predetermined period of time is needed to exhaust the combustion gas, so the exhaust valve is opened before the piston reaches the bottom dead center (BDC) to exhaust the combustion gas. Thus, the pressure in the combustion chamber is lowered before the piston reaches the bottom dead center (BDC), and it causes heat loss.

In the piston compressed turbine engine of the present invention, the exhaust valve is opened after combustion is completed and power is generated during the expansion and exhaust process. The length of the expansion and exhaust process of the piston cam rotor can be set so as to exhaust combustion gases sufficiently. Then, by appropriate setting of an opening period of the exhaust valve, exhaust blow-down loss can be minimized.

(4) Mechanical loss

It is known that friction due to gas pressure is mainly influenced by the peak pressure. In the conventional piston engine, considerable frictional loss of the piston and bearing occur due to the high pressure combustion gases in the cylinder during the expansion stroke. In the piston compressed turbine engine of the present invention, however, while high pressure combustion gases exist in the cylinder, the piston is paused and the piston rod is firmly fixed to the cylinder block so that there is no frictional loss due to the high pressure combustion gases.

Also, as the rotation speed or piston speed increases, inertia increases and mechanical friction due to inertia is increased. In the piston compressed turbine engine of the present invention, since a variety of piston ascending/descending track of the piston cam rotor can be designed to obtain several operation cycles per rotation of the power shaft, large power can be obtained with less number of rotations and thus the mechanical friction loss can be reduced.

The other theoretical performance of the piston compressed turbine engine of the present invention is as follows.

(1) The volumetric efficiency due to compression pressure

Theoretically, it is ideal that the compression stroke begins from BDC. However, in the conventional piston engine, because of the delay in intake due to the inertia of air or air-fuel mixture, the intake valve is closed after passing BDC and then compression begins. Accordingly, the effective compression ratio is lowered by 10-20% compared to the compression ratio calculated from the piston stroke.

In contrast, in the piston compressed turbine engine of the present invention, when the piston reaches BDC, it pauses for a while to get rid of the delay effect in intake due to the inertia of air or air-fuel mixture. Then, the exhaust valve is closed and compression begins. So the effective compression ratio is almost the same as the compression ratio calculated from the piston stroke and the volumetric efficiency is high.

(2) The volumetric efficiency due to temperature transfer and engine speed

The volumetric efficiency of the piston compressed turbine engine of the present invention exhibits features different from those of the piston engine in the temperature of a cylinder walls and rotation speed.

That is, as the cylinder temperature increases, the volumetric efficiency is lowered. In the piston compressed turbine engine of the present invention, since high temperature combustion gases does not contact the inside wall of the cylinder, the temperature of air or air-fuel mixture is relatively lowered and thus the volumetric efficiency is improved. Also, as the rotation speed increases, the volumetric efficiency decreases since the velocity of the air or air-fuel mixture in the intake manifold, port, and valve increases. In the piston compressed turbine engine of the present invention, since the operation of the engine is possible at a low rotation speed, the volumetric efficiency is improved.

(3) Combustion process in air-fuel cycle

In general, within the allowable limit of the peak pressure and rising ratio of the pressure of engines increasing ratio, it is desirable to obtain high power output and efficiency that to proceed combustion under the constant volume as much as possible. However, due to the structural and operational characteristics, in the case of Diesel engine, combustion is proceeded in the ratio of constant volume combustion of 30%, constant pressure combustion of 50%, and a constant temperature combustion of 20% and, in the case of Otto engine, combustion is proceeded in the ratio of constant volume combustion of 50%, constant pressure combustion of 30%, and a constant temperature combustion of 20%. In the case of the turbine engine, most is constant pressure combustion.

In contrast, in the case of the piston compressed turbine engine of the present invention, during when combustion is proceeded, the piston is paused and the exhaust valve remain closed until the combustion is completed. Thus, the flame propagation distance is short and most is constant volume combustion.

(4) Exhaust pressure

When the exhaust valve begins to open, the cylinder pressure of Otto engine is about 4 atm and that of Diesel engine is about 3 atm. The energy equivalent to a balance between the above cylinder pressure and the pressure outside the engine (about 1 atm on the surface of the earth under the general atmosphere) becomes loss so that efficiency is lowered accordingly.

However, in the piston compressed turbine engine of the present invention, the pressure of the exhaust gas at the tail end of turbine blade is the sum of the atmospheric pressure and the pressure due to the resistance of the exhaust mechanism.

Also, in the turbine engine, in order to make the air compressed by the compressor continuously flow into the combustion chamber and the combustion gas flow toward the turbine only, not back to the compressor, it is essential to keep the pressure of the compressed air and combustion gases in the engine from the tail end of the compressor to the leading end of the turbine via the combustion chamber decreased gradually. So design and manufacture of the turbine engine is complicated and difficult.

However, in the piston compressed turbine engine of the present invention, since the combustion gas flows through the exhaust manifold only toward the turbine not back toward the intake manifold, design and manufacture of the engine is simple.

(5) Pump loss

Since the pressure in the cylinder is lower than the atmospheric pressure during the intake stroke and the pressure in the cylinder is higher than the atmospheric pressure during the exhaust stroke, a negative power with respect to the output power of the engine is needed so that the piston performs intake stroke and exhaust stroke. This is referred to as pump loss.

In the piston compressed turbine engine of the present invention, since exhaust stroke by the piston is not required, pump loss hardly occurs.

In addition, it is advantageous in the piston compressed turbine engine of the present invention that since the direct rotational power by the turbine is generated as in the turbine engine, impact on the moving parts and vibration of engine are greatly reduced in comparison with those of the conventional piston engine. Also, since the piston rod in the piston compressed turbine engine of the present invention moves forward or backward lineally on the axis of piston head center, piston slap or piston side knock occurring in the conventional piston engine due to the crank angle between crank shaft and connecting rod does not occur.

Further, in the conventional piston engine, since the piston continuously moves, cooling of the piston head is difficult and a heat endurance feature of the piston is an important point to be considered. In the piston compressed turbine engine of the present invention, since the piston pauses for a predetermined period of time by contacting the cylinder head during the combustion and power process, cooling of the piston head can be smoothly performed through heat transfer to cylinder head which is maintained as relatively low temperature than piston head.

Also, in the conventional turbine engine, since the impeller continuously contacts the combustion gas, cooling of the impeller is difficult, and the manufacture of the engine is complicated with the increase of the cost. In contrast, in the piston compressed turbine engine of the present invention, since the combustion gas contacts impeller intermittently, the impeller of the turbine portion can be sufficiently cooled by blowing a relatively low temperature compressed air by the compression cylinder of an auxiliary compressor to the impeller. Thus, manufacture of a relatively economic impeller is possible.

In the meantime, a method of controlling the piston compressed turbine engine according to the present invention is described below.

In a piston compressed turbine engine of the present invention, the air or air-fuel mixture is drew into the cylinder and compressed as a piston reciprocates, a high-pressure combustion gas obtained by exploding the compressed air-fuel mixture rotates a turbine, and the rotation power of the turbine reciprocates the piston. The method of controlling includes a piston retreat step in which air or air-fuel mixture is drew into the cylinder as the piston retreats at the state of the intake valve open, a piston pause-at-BDC step in which the piston pauses for a predetermined time at the BDC so that delay in intake due to inertia of the inducted air or air-fuel mixture can be reduced, a piston advancing step in which the inducted air or air-fuel mixture is compressed as the piston advances at the state of the intake valve closed, and a piston pause-at-TDC step in which the piston pauses for a predetermined time at the TDC so that the compressed air-fuel mixture explodes in the constant volume state and combustion gas generates power and exhausted after the combustion is completed and the exhaust valve open.

That is, to perform the above steps, the piston is preferably controlled in a way that the ideal gas standard cycle of air-fuel mixture in the engine forms a constant-pressure curve during the intake, an adiabatic compression curve during the compression, a constant-volume curve during the combustion, an adiabatic expansion curve during the generation of power, and a constant-pressure curve during the exhaust.

Also, in the above steps, to change rotational torque output of an engine during one turn of the power shaft, the track can be formed so that the cycle including the retreat section, the pause-at-BDC section, the advancing section, and the pause-at-TDC section repeats N times. This enables N times of combustion for each cylinder when the power shaft of the turbine rotates one time, so rotational torque can be controlled.

While this invention has been particularly shown and described with reference to preferred embodiments thereof, it will be understood by those skilled in the art that various changes in forms and details may be made therein without departing from the spirit and scope of the present invention as defined by the appended claims.

For example, in the preferred embodiment of the present invention, an oscillating cam assembly is used to control the piston portion. However, any controller controlling the piston portion by the turbine portion driven by using combustion gas exhausted from the piston portion and various types and shapes of the piston portion can be applied.

As described above, in the piston compressed turbine engine of the present invention and a controlling method thereof, a superior thermodynamic performance analyzed using the ideal gas standard cycle can be obtained along with high output and efficiency. Since a combustion delay phenomenon is not occurred at a high speed, heat loss can be reduced. Since a contact area with a high temperature combustion gas is limited, a cooling burden is reduced. Since the expansion/exhaust duration can be adjusted properly, exhaust blow-down loss can be lowered. Since the piston pauses at the TDC continuously during the combustion and expansion/exhaust process, mechanical friction loss is reduced. Large power can be obtained at a low R.P.M. A volumetric efficiency of compression is high. Operation of the engine is possible at a low R.P.M. A volumetric efficiency of intake is high. Since a flame propagation distance is short when the combustion is performed, a complete combustion in a constant volume combustion state is possible. Since the pressure of the combustion gas at the outlet of the turbine is low, noise and vibration are reduced. Since there is no exhaust stroke by the piston, pump loss is reduced. Since the emission of contaminants is prevented due to constant volume combustion, the engine is pro-environmental. Since the power shaft of the turbine and the shaft of the piston are arranged parallel to each other, mechanical apparatuses and parts can be made simple, and a compact and light engine can be realized. The control of each part of the engine such as the reciprocation speed and pause time of the piston and optimal manufacture can be facilitated.

What is claimed is:

1. A piston compressed turbine engine wherein the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston.

2. A piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and the piston is paused for a predetermined time at the TDC during the explosion so that constant volume combustion of air-fuel mixture is performed.

3. A piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and an oscillating cam assembly having a track formed therein for oscillating a piston rod when the rotor rotates is installed between the power shaft of the turbine portion and the piston rod of the piston portion to control the reciprocation of the piston.

4. The piston compressed turbine engine as claimed in claim 3, wherein the track comprises:
a retreat section in which air or air-fuel mixture is drew into the cylinder as piston retreats;
a pause-at-BDC section in which the piston pauses for a predetermined time at the BDC so that delay in intake due to inertia of the inducted air or air-fuel mixture can be reduced;
an advancing section in which the inducted air or air-fuel mixture is compressed as the piston advances; and
a pause-at-TDC section in which the piston pauses for a predetermined time at the TDC so that the compressed air-fuel mixture explodes in the constant volume state and combustion gas generates power and exhausted after the combustion is completed.

5. The piston compressed turbine engine as claimed in claim 4, wherein, in the track, the boundary of each section is chamfered as round and the inclination of the track in each section is optimally designed such that an impact by inertia, pressure and friction, etc. applied to the piston portion and controlling apparatus is minimized.

6. A piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and ideal gas standard cycle of the air or air-fuel mixture in the engine is controlled to form an constant-pressure curve during the intake, an adiabatic compression curve during the compression, a constant-volume curve during the combustion, an adiabatic expansion curve during the generation of power, and an constant-pressure curve during the exhaust.

7. A piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and, at the TDC, most part of the upper surface of the piston head contacts an inner surface of the cylinder block facing the upper surface of the piston head to cool down the piston head by transmission, and the other part of the upper surface of the piston head contacts a combustion chamber which is encompassed by the cylinder block, part of the upper surface of the piston, and intake and exhaust valves, and the part of the upper surface of the piston to minimize the contact area between the piston and combustion gas

8. A piston compressed turbine engine wherein the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and, to prevent transmission of impact caused by combustion gas to the oscillating cam assembly, the piston rod intermittently rotates and is selectively locked to a cylinder block.

9. A piston compressed turbine engine comprising:
a piston portion where air or air-fuel mixture is drew into a cylinder and compressed by a piston that repeats reciprocation and pause, the compressed air-fuel mixture explodes, and a high pressure combustion gas generated during the explosion is exhausted;
a turbine portion where an rotational power of a power shaft is generated using the high-pressure combustion gas exhausted from the piston; and
a controlling apparatus which transfers part of the rotational power generated at the turbine portion to the piston portion and controls reciprocation of the piston so that the piston of the piston portion retreats during the intake of the air or air-fuel mixture, advances during compression, and pauses during combustion and expansion/exhaust of the combustion gas.

10. The piston compressed turbine engine as claimed in claim 9, wherein the piston portion comprises:
a cylinder block in which an intake manifold and an exhaust manifold are installed at the front side of the cylinder block, a combustion chamber is separately formed to reduce a contact area between the piston and the combustion gas, and a piston is inserted into the rear side of the cylinder block;
a piston head installed to be capable of sliding by being inserted into a cylinder of the cylinder block;
a piston rod connected to the rear side of the piston head and extending outside the cylinder block;
an intake valve installed at the intake manifold of the cylinder block for opening and closing an intake manifold to control flow of the air or air-fuel mixture drew into the cylinder;
an intake valve cam assembly connected to the power shaft of the turbine portion for converting a rotational movement of the power shaft to reciprocation of the intake valve;
an exhaust valve installed at the exhaust manifold of the cylinder block for opening and closing an exhaust manifold to control flow of the combustion gas exhaust outside the cylinder; and
an exhaust valve cam assembly connected to the power shaft of the turbine portion for converting a rotational movement of the power shaft to reciprocation of the exhaust valve.

11. The piston compressed turbine engine as claimed in claim 10, wherein a shock absorber is installed between the piston head and the piston rod to reduce an impact applied to the piston rod through the piston head.

12. The piston compressed turbine engine as claimed in claim 10, wherein the intake valve cam assembly comprises:
an intake valve rod disposed at the outer circumferential surface of the cylinder block and connected to the intake valve; and
an intake valve cam rotor in which an intake valve cam track with protrusion and depression is engraved so that an end portion of the intake valve rod contacts and slides along the edge of the intake valve cam track, and which is connected to the power shaft to rotate together with the power shaft, and
the exhaust valve cam assembly comprises:
an exhaust valve rod disposed at the inner front of the cylinder block and connected to the exhaust valve; and
an exhaust valve cam rotor in which an exhaust valve cam track with protrusion and depression is engraved so that an end portion of the exhaust valve rod contacts and slides along the edge of the exhaust valve cam track, and which is connected to the power shaft to rotate together with the power shaft.

13. The piston compressed turbine engine as claimed in claim 10, further comprising a piston head cooling unit for cooling the piston head by contacting the inner surface of the cylinder block facing the upper surface of the piston head to the upper surface of the piston head when the piston is at TDC.

14. The piston compressed turbine engine as claimed in claim 13, wherein the piston head cooling unit in which to make the upper surface of the piston head evenly contacts the inner surface of the cylinder block facing the upper surface of the piston head as the piston head rotates at a predetermined angle for each operation cycle comprises:
an inner piston at the piston rod and an inner cylinder at the piston head that are separately formed between the piston head and the piston rod; and
a toothed surfaces with one-way rotational incline formed on each of the lower surface of the inner piston and the bottom of the inner cylinder, facing and corresponding to each other.

15. The piston compressed turbine engine as claimed in claim 10, further comprising:
a ignition apparatus installed at the combustion chamber for forcibly igniting the compressed air-fuel mixture; and
a control portion for controlling the ignition apparatus.

16. The piston compressed turbine engine as claimed in claim 9, wherein the turbine portion comprises:
a power shaft installed at the center of the cylinder block to be able to rotate freely; and
a impeller connected to the power shaft, installed at an integrated exhaust manifold formed by incorporating numbers of exhaust manifolds of the cylinder block, and rotating by the energy of the combustion gas exhausted from the exhaust manifolds.

17. The piston compressed turbine engine as claimed in claim 16, further comprising an air-cooled cooling unit for cooling the impeller.

18. The piston compressed turbine engine as claimed in claim 17, wherein the cooling unit is a compression cylinder compressing air by using a rotation power of the power shaft and blowing the compressed air to the impeller.

19. The piston compressed turbine engine as claimed in claim 9, wherein the controlling apparatus is an oscillating cam assembly for oscillating the piston rod by a rotor where ascending/descending track with protrusion and depression is engraved.

20. The piston compressed turbine engine as claimed in claim 19, wherein the oscillation cam assembly comprises:
a piston cam rotor, rotating together with the power shaft, in which a piston ascending/descending track with protrusion and depression in which the bearing ball is inserted and slides so that the piston rod reciprocates together with the bearing ball is engraved and a fixing shaft is at the center thereof to fix to or detach from the power shaft; and
a bearing ball installed at one end of the piston rod and inserted into the piston cam rotor to convert rotation of the power shaft to reciprocation of the piston rod.

21. The piston compressed turbine engine as claimed in claim 20, wherein the piston ascending/descending track comprises:
a retreat section in which air or air fuel mixture is drew into the cylinder as the piston retreats;
a pause-at-BDC section in which the piston pauses at the BDC for a predetermined time to reduce a delay in intake due to inertia of the inducted air or air-fuel mixture;
an advancing section in which the inducted air or air-fuel mixture is compressed as the piston advances; and
a pause-at-TDC section in which the piston pauses at the TDC for a predetermined time, constant volume combustion is proceeded, and after combustion is completed, a combustion gas rotates the turbine and is exhausted,
wherein the height and inclination of the track (the height and position of mountain and furrow) are determined corresponding to an intake stroke, a compression stroke, a combustion process, and an expansion/exhaust process in harmony with the operation of the intake valve and exhaust valve.

22. The piston compressed turbine engine as claimed in claim 21, wherein, in the piston ascending/descending track, the boundary of each section is chamfered as round, inclination of the track of each section is formed such that the inclination angle gradually increases in the retreat section and gradually decreases in the advancing section so that an impact applied to the piston according to a load acting on the piston is minimized, and in the pause-at-TDC section, track is located slightly lower than the TDC during the combustion and expansion/exhaust proceed.

23. The piston compressed turbine engine as claimed in claim 21, wherein, in the piston ascending/descending track, to change a rotational torque output of the engine during one turn of the power shaft, a cycle including the retreat section, the pause-at-BDC section, the advancing section, and the pause-at-TDC section repeats N times so that N times of combustion per turn of the power shaft is performed at every cylinder.

24. The piston compressed turbine engine as claimed in claim 19, wherein, to enable the piston rod intermittently rotates such that the piston rod is locked to a cylinder block when the compression is completed and is released from the cylinder block when the exhaust is completed, so that a load of combustion gas applied to the piston is prevented from being transmitted to the piston cam rotor, the oscillation cam assembly comprises:
a guiding protrusion which is sporadically extruded at each side wall of the piston ascending/descending track to guide the sporadic axial rotation of the piston rod, incorporated into the piston cam;
a rod-rotating protrusion protruding from the middle of the piston rod and integrally formed with the piston rod which is inserted in the piston ascending/descending track corresponding to the double line type guiding protrusions of the piston cam rotor, and rotates the piston rod in the axial direction as twisted by the double line type guiding protrusions; and
a rod-locking protrusion protruding from the middle of the piston rod and integrally formed with the piston rod which has a shape corresponding to a rod-guiding window formed in the lower surface of the cylinder block and is selectively enabled or disabled to move through the rod-guiding window according to the rotation angle of the piston rod.

25. The piston compressed turbine engine as claimed in claim 24, wherein the rod-rotating protrusion includes a locking-rotation protrusion formed at the middle of the piston rod and a releasing-rotation protrusion formed at the bearing-ball side tip of the piston rod, and the rod-locking protrusion is a butterfly shaped.

26. The piston compressed turbine engine as claimed in claim 10, wherein the cylinder block is formed in N tiers such that at least one cylinder is arranged at an identical angle in a single tier around the power shaft at a predetermined distance (L1) in the same direction as the power shaft of the turbine portion and, to increase the output of the engine, another cylinder is arranged at an identical angle in double tiers horizontally forming at other distance (L2) with respect to the power shaft.

27. The piston compressed turbine engine as claimed in claim 9, wherein a set of the piston compressed turbine engine including the piston portion, the turbine portion, and the control portion and power shafts of other N sets of the engines are connected in series.

28. The piston compressed turbine engine as claimed in claim 9, wherein a set of the piston compressed turbine engine including the piston portion, the turbine portion, and the control portion and another set of the engine arranged in the opposite direction are connected to opposed to each other.

29. The piston compressed turbine engine as claimed in claim 28, wherein the opposed control portion is a double opposed track in which the piston ascending/descending track formed in the piston cam rotor of the oscillation cam assembly for ascending/descending the piston of the piston portion is formed of a forward directional ascending/descending track and a reverse directional ascending/descending track which are reverse symmetrical.

30. A piston compressed turbine engine comprising:
a piston portion where air or air-fuel mixture is drew into a cylinder and compressed by a piston that repeats reciprocation and pause, the compressed air-fuel mixture explodes, and a high pressure combustion gas generated during the explosion is exhausted;
a turbine portion where an rotational power of a power shaft is generated using the high-pressure combustion gas exhausted from the piston; and
a controlling apparatus which transfers part of the rotational power generated at the turbine portion to the piston portion and controls reciprocation of the piston so that the piston of the piston portion retreats during the intake of the air or air-fuel mixture, advances during compression, and pauses during combustion and expansion/exhaust of the combustion gas,
wherein the piston portion comprises:
a multi-cylinder type cylinder block in which intake manifolds and exhaust manifolds are installed at the turbine side of the cylinder block, a combustion chamber is separately formed to reduce a contact area between the piston and the combustion gas, a piston is inserted into the cylinder, and at least one cylinder is arranged at an identical angle around and parallel with the power shaft of the turbine portion;
a piston head installed to be able to slide by being inserted into a cylinder of the cylinder block;
a piston rod connected to the rear side of the piston head and extending outside the cylinder block;
an intake valve installed at the outlet of the intake manifold of the cylinder block for opening and closing the intake valve to control flow of the air or air-fuel mixture drew into the cylinder;
an intake valve cam assembly connected to the power shaft of the turbine portion for converting a rotational movement of the power shaft to reciprocation of the intake valve;
an exhaust valve installed at the inlet of the exhaust manifold of the cylinder block for opening and closing the exhaust valve to control flow of the combustion gas outside the cylinder; and
an exhaust valve cam assembly connected to the power shaft of the turbine portion for converting a rotational movement of the power shaft to reciprocation of the exhaust valve, and
the turbine portion comprises:
a power shaft installed at the center of the cylinder block to be able to rotate freely; and
a impeller connected to the power shaft, installed at an integrated exhaust manifold formed by incorporating a plurality of exhaust manifolds of the cylinder block, and rotating by a force of the combustion gas exhausted from the exhaust manifolds, and
the control unit is an oscillation cam assembly for oscillating the piston rod by a rotor where ascending/descending track is engraved.

31. A method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston, the method comprising the acts of:
drawing air or air-fuel mixture into the cylinder as the intake valve is open and the piston retreats (a retreat act);
pausing the piston at the BDC for a predetermined time so that the delay in intake due to inertia of the inducted air or air-fuel mixture is removed (a pause-at-BDC act);
compressing the air or air-fuel mixture as the piston advances (an advancing act); and
pausing the piston at the TDC for a predetermined time so that constant volume combustion is performed during explosion and combustion gas rotates the turbine after combustion is completed and then is exhausted (an pause-at-TDC act).

32. A method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, and the rotational power of the turbine reciprocates the piston, wherein air cycle of the air or air-fuel mixture in the engine is controlled to form an constant-pressure curve during intake, an adiabatic compression curve during compression, a constant volume curve during combustion, an adiabatic expansion curve during expansion, that is, the generation of power, and an constant pressure curve during exhaust.

33. A method of controlling a piston compressed turbine engine in which the air or air-fuel mixture is drew into the cylinder and compressed as a piston reciprocates, a high-pressure combustion gas obtained by exploding the compressed air-fuel mixture rotates a turbine, the rotational power of the turbine reciprocates the piston, and an oscillating cam assembly having a track formed therein for oscillating a piston rod by a rotor that rotates is installed between the power shaft of the turbine and the piston to control the reciprocation of the piston, wherein, to change a rotational torque output of the engine during one turn of the power shaft, a rotational torque is controlled by forming a cycle including the retreat section, the pause-at-BDC section, the advancing section, and the pause-at-TDC section to repeat N times in the track so that N times of combustion per cylinder are made while the power shaft of the turbine portion rotate one turn.
